(19) United States
(12) Patent Application Publication
(10) Pub. No.: US 2010/0307078 A1
(43) Pub. Date: Dec. 9, 2010

(54) REPAIR AND REINFORCEMENT SYSTEM AND METHOD FOR DOORS AND JAMBS

(76) Inventor: Glenn I. Young, Richmond, VA (US)

Correspondence Address: Thomas & Karceski, P.C., 536 GRANITE AVENUE, RICHMOND, VA, 23226, US

(21) Appl. No.: 12/840,394

(22) Filed: Jul. 21, 2010

Related U.S. Application Data
(63) Continuation-in-part of application No. 12/276,671, filed on Nov. 24, 2008.

(51) Int. Cl. E04B 1/92; E06B 1/52; E06B 1/04

(52) U.S. Cl. 52/204.1; 52/745.15; 52/745.05

(57) ABSTRACT

A door security system serves to substantially improve the reliability of the entire door assembly. The system comprises components generally having an L-shaped cross section. One or more components may be mounted on a vertical jamb member on the hinge side of the door jamb. The components include sleeves that wrap on two sides around the vertical jamb member to reinforce and stabilize the door system.

### CROSS-REFERENCE TO RELATED APPLICATIONS

This application is a continuation-in-part of and claims priority to U.S. application Ser. No. 12/276,671, filed Nov. 24, 2008, which is incorporated by reference herein in its entirety.

### FIELD OF THE INVENTION

The present invention relates to a door security system, specifically to a mounting system for reinforcement, repair and improved security of door assemblies including but not limited to those with sidelights, wooden enclosures and jamb members.

### BACKGROUND OF THE INVENTION

There is an ever increasing need and demand for improving the security and structural integrity of entry doors, in particular doors with sidelights. This demand is being driven by the repeated occurrences of unauthorized and forced entry through entry doors with sidelights. A sidelight is a window, typically non-operable, that is adjacent an entry door. As seen in FIG. 2, an entry door assembly with sidelights typically comprises the door slab (10), one or two sidelight panels (19) on one or both sides of the door slab (each sidelight panel typically comprising either a full length sidelight in a frame or (as seen in FIG. 1) a less than full length sidelight and a solid panel both mounted in a frame), and one (if one sidelight) or two (if two sidelights) jamb stanchions (12, 14) running vertically from a header (22) (also termed an upper horizontal jamb member) to a sill (28) (also termed a lower horizontal jamb member) in between the sidelight and the door slab. The stanchion between the sidelight and the free swinging side of the door houses the strike plate and receives the door latch and/or dead bolt. If there is a sidelight on the hinge side of the door, the hinges are mounted to the stanchion between the sidelight and the hinge side of the door. If there is not a sidelight on the hinge side of the door, the hinges are mounted to the door jamb instead.

Typically such improvements have focused on pick resistant locks, longer and stronger dead bolts, and guard plates. Generally the strengthening and protecting of the locks and bolts have proven to be ill fated attempts at increasing the security of entry doors. The fact is these locks and bolts are mounted and anchor into very soft wooden door slabs and jambs, making their overall effectiveness minimal for security purposes when utilized without overall reinforcement. Traditionally the lock bolt is located in the door slab close to and passing through the doors edge. With this arrangement any significant force applied to the door assembly will cause it to yield and thereby allowing the dead bolt to rip through the door slab. As well the bolt extends into the door jamb through a strike plate that is held in place by short screws. These screws only extend a short distance into the door stanchion to secure the strike plate around the receiving opening that is located very close to the inner edge of the stanchion. The resulting orientation of the lock bolt, strike and receiving opening means that a thin section of the wooden stanchion is all that remains to resist inward motion of the door slab when the lock bolt is engaged. With this arrangement a person may cause the bolt to rip through the retaining section of the door assembly or jamb merely by applying sufficient force to the door slab itself. Consequently forced entry may be gained without any disturbance or defeat of the security offered by the locking device. Furthermore, due to the construction of doors with sidelights, the jamb stanchions are only secured to the upper jamb and sill plate with minimal hardware that is easily defeated as well.

Historically, one point of forced entry for sidelight doors has been the door stanchion—specifically in the region where the free-swinging edge of the door slab interfaces with the strike plate area of the corresponding stanchion. On doors assemblies with deadbolt locks and wooden door slabs or steel door slabs with wooden cores, the wooden stanchions—particularly in the area where the bolt of the locking mechanism is common to both the door and the stanchion—are considerably inadequate. Consequently, prior devices are designed for strengthening and reinforcing this area. These devices did further the structural support of the door assembly, yet overall these devices have considerable shortcomings. To begin with, these devices did nothing to strengthen the overall door assembly so any applied force was merely transferred to another point of weakness. As well these devices were frequently aesthetically unacceptable and designed for only type of application. Their design features also made installation difficult for a traditional layperson. In some cases the visibility of the device made it more easily defeated. Furthermore it should be noted that in many instances such reinforcement devices are sought after the occurrence of forced entry and damage to the door stanchion. The presence of this damage on the existing door assembly will prohibit use of the current devices and prohibit proper application of the strike plate.

Yet other prior art consists of a door shield or cover plate that wraps around the door from the interior side through the lock area to the exterior. These U-shaped door shields position on the free swinging edge of the door slab with the side panels overlying and extending along opposite sides of the door slab and are typically secured in position by the locking mechanism. Door shielding devices will offer some degree of protection to the door slab, however due to their construction are limited in security they offer. These devices are either outdated, made of material that is more decorative than strength oriented, or are only designed for one lock. As well they offer minimal security when singularly applied.

Still other devices were developed to support and strengthen the door stanchions in the area corresponding to the mounting of the hinges on vertical hung doors. Again these devices are difficult to install in the afforded space of existing doors or require significant detailed finish carpentry to properly complete application.

Though these prior art devices were realized with the best intent, the need still exists for a door security device that focuses on the overall structural inadequacy of doors mounted in and supported by wooden stanchions. The current art fails to produce a system that equally and complementary addresses the conventional points of forced entry and structural vulnerability of vertically hung side lit door assemblies for new and existing structures. Though much of the available prior art will afford greater strength, stability and support of vertically hung hinged doors they nevertheless suffer from a number of disadvantages:

1. The design of the current art does not permit repair of broken door jambs while the door and jamb are still hung in place. Thus the door must be replaced or removed to allow the jamb to be repaired prior to deploying these devices.

2. The design of the current art is not easily adaptable for use on sidelight doors.

3. In many instances the current devices cannot be used on jambs that are damaged.

4. The current devices often have visible parts that are unsightly. This takes away from the overall aesthetics of the door.

5. The current devices that are installed on the backside of the jamb are difficult to hold in place and align while being attached. Significant effort is required to ensure the backing plate stays firmly against the jamb.

6. Due to the material thickness of these jamb reinforcement devices or the method of installation, several of them require considerable finish carpentry skill to install. These requirements would make installation difficult for a layperson.

7. In some cases the visibility of these devices makes them easier to defeat.

8. Many of the components are ineffective due to their singular nature and individual deployment. Using components separately limits the security they can offer.

9. Construction and materials make current devices unsightly. Their finish can also limit there application due to inability to be painted easily or at all.

10. The devices in current use are made from relatively soft material or materials that limit their application as practical security products by design.

11. The hinge and jamb reinforcement and protectors in current use do not wrap around the jamb. Thus their overall effectiveness for securing and reinforcing the doorjamb is limited by design.

12. The current devices do not offer adaptability for door components outside the realm of modern day industry standard.

### BRIEF SUMMARY OF THE INVENTION

It is an object of the present invention to overcome the foregoing drawbacks and shortcomings of the current state of art with door security assemblies that focus on the overall structural inadequacy of sidelight doors mounted in and supported by wooden assemblies. The present system can be used alone or in combination to equally and complimentarily address the conventional points of forced entry and structural vulnerability of vertically hung hinged doors with sidelights for new and existing structures by utilizing wrapping technology. Component parts of the system are generally obscured from view by design. The present invention affords greater strength, stability and support to doors with sidelights that has not been heretofore achieved, in such a manner. As well an object of the present invention is to provide a structurally sound means of repair for previously damaged said door assemblies. After installation, the component parts alone or in combination cooperate to substantially benefit and enhance the structural integrity of entry door assemblies with sidelight applications.

As previously disclosed the present invention is for vertically hung hinged entry non-standard door assemblies including but not limited to those with sidelights and particularly suited for doors with wooden stanchions and doorjambs. The door assemblies will consist of a four sided wooden enclosure (the fours sides being a substantially horizontal header at the top, a substantially horizontal sill at the bottom, and substantially vertical jambs on either side) with two wooden door jamb stanchions substantially vertically oriented within the enclosure and affixed at the top to the header and at the bottom to the sill. One jamb stanchion typically has three hinges on the facing or medial side to hingedly affix the door slab to the door assembly. Between the vertical jamb sections and the jamb stanchions there will be decorative sidelight panels installed. The assembly components also typically include a door sealing surface (e.g., weatherstripping) that will be situated in the offset surface of the doorjamb and rests against the exterior face of the door slab when in the closed position. Typically there will be a latch bolt lock situated below a dead bolt lock, installed in typical fashion. The door jamb stanchion adjacent to the free swinging edge of the door will have openings positioned so as to allow the plunger portion of the dead bolt to engage a strike plate and be received into the door jamb upon closure and lock activation.

The door security system presented here will serve to substantially improve the reliability of the entire door assembly and particularly those with sidelights. This system will comprise several main components all suitably manufactured of rugged material, preferably steel, and all necessary securing hardware. Securing hardware will depend upon the door application and will be appropriately sized to securely mount the components to the door jamb stanchions immediately surrounding the door and also secure the entire door assembly to the rough frame of the main structure. It can be incorporated into the manufacturing process of door assemblies, applied cooperatively to new assemblies, or installed on previously hung door assemblies as functions of the overall system benefit. The latter application can be done by the average layperson with basic hand tools and minimal carpentry experience. Thus significant features of the present invention include allowing for application of the system on previously installed door assemblies and the repairing of damaged assemblies while originally placed, in simple and uncomplicated fashion. The lack of complexity is achieved by the thin three sided wrapping construction of the components, which allows them to easily slide onto position in the applicable areas.

Installation is accomplished by first removing the interior door jamb decorative trim molding and cutting or removing the fasteners. This will include removing at least two screws from each hinge to be modified. Next, install the system components in their corresponding locations and verify the frame is still square. Finally, secure the finished frame to the rough frame with the proper hardware while at the same time securing all system components. Once installed the majority of the system is totally concealed on a closed door that has been properly hung and finished in normal fashion.

With this system, as previously stated, the components can work together to ensure greater strength, stability and support of vertically hung hinged doors including those with sidelights or similarly constructed. The components that can be combined to make up this system and their function will follow:

1. The free-swinging side upper door jamb stanchion shielding component corresponding to the door slab free swinging edge and coinciding door jamb stanchion will be an elongated section of about 16-24 gauge steel sheet metal or other rugged material that is generally configured to form an L shaped cross section The free-swinging side upper door jamb stanchion shielding component serves to wrap around the upper doorjamb stanchion section from the facing surface of the doorjamb stanchion adjacent the free-swinging edge of the door slab and around to the interior surface of the stanchion. The side of the shield corresponding to the longer leg of the L is positioned on the jamb stanchion immediately adjacent the free swinging door edge, while the side of the shield corresponding to the shorter leg of the L is situated against the interior edge of the same stanchion member. The free-swinging side upper door jamb stanchion shielding component mounts on the jamb stanchion such that it flushly contacts the interior edge of the door jamb and the facing surface of the jamb stanchion, while extending upward and downward in close proximity to the door jamb stanchion in both directions. When positioned accordingly, the extension flange at the top of the component will extend over and be secured to the upper rough frame and the extension flange at the bottom of the component will extend over and be secured to a portion of the door jamb stanchion. Alternatively a single top flange may extend and bend perpendicular to the facing surface of the shield, while being positioned in direct contact to the upper door jamb. These flanges, when secured, increase the rigidity of the overall assembly. The L shape feature of the sleeve, in combination with the adjustability and securing flanges, are major factors in the uniqueness of this component and the present system of invention. The technology allows the doorjamb stanchion to be wrapped and braced and, once secured with screws, the stability of the jamb stanchion and door assembly is substantially increased. The free-swinging side upper doorjamb stanchion shielding component has considerations for new manufactured door assemblies and may be modified for adjustability as well as incorporated into the doorjamb stanchion area prior to application of the door assembly weather seal at the factory.

2. The center door jamb shielding component corresponding to the door slab free swinging edge and coinciding door jamb stanchion will be an elongated section of about 16-24 gauge steel sheet metal or other rugged material that is generally configured to form an L shaped cross section. The free-swinging side center door jamb shielding component serves to wrap around the door jamb stanchion from the facing surface of the door jamb stanchion adjacent the free swinging edge of the door slab and around to the interior surface of the stanchion. The side of the shield corresponding to the longer leg of the L is positioned on the jamb stanchion immediately adjacent the free swinging door edge, while the side of the shield corresponding to the shorter leg of the L is situated against the interior edge of the same stanchion member. The free-swinging side center door jamb shielding component mounts on the jamb stanchion such that it flushly contacts the interior edge of the door jamb and the facing surface of the jamb stanchion, while extending upward and downward in close proximity to the door jamb stanchion in both directions. In the region of the free swinging edge of the door slab and bolt receiving holes of the door jamb stanchion, there will be cutouts or knockouts placed in the shield that can be removed to appropriately accommodate upper and lower lock bolts. Typically the lock arrangement will comprise a dead bolt lock oriented above a latch bolt lock. The suitably sized dead bolt lock when manipulated will pass through the shield and proceed into the original wooden door jamb. The length of the center jamb shielding component and its L shaped feature serve to spread any force applied to the door jamb stanchion while transferring such load to the entire door assembly surrounding structure, thereby preventing the splitting of the door jamb stanchion. The technology allows the door jamb stanchions to be wrapped and, once secured with screws, the rigidity of the stanchion is significantly increased. The free-swinging side center door jamb shielding component has considerations for new manufactured door assemblies and may be incorporated into the door jamb stanchion with minor modification, prior to application of the door assembly weather seal at the factory.

3. The lower door jamb stanchion shielding component corresponding to the door slab free swinging edge and coinciding door jamb will be an elongated section of about 16-24 gauge steel sheet metal or other rugged material that is generally configured to form an L shaped cross section. The free-swinging side lower door jamb stanchion shielding component serves to wrap around the lower door jamb stanchion section from the facing surface of the door jamb adjacent the free swinging edge of the door slab and around to the interior edge of the stanchion. The side of the shield corresponding to the longer leg of the L is positioned on the jamb stanchion immediately adjacent the free swinging door edge, while the side of the shield corresponding to the shorter leg of the L is situated against the interior edge of the same stanchion member. The free-swinging side lower door jamb stanchion shielding component mounts on the jamb stanchion such that it flushly contacts the interior edge of the door jamb and the facing surface of the jamb stanchion, while extending upward and downward, in close proximity to the door jamb stanchion in both directions. When positioned accordingly, a bendable tab near the bottom of the component will bend inward and will receive a screw, thereby enabling the screw to be secured at an angle into the sill plate. Alternatively a single bottom flange may extend and bend perpendicular to the facing surface of the shield, while being positioned to be in direct contact and incorporated into the jamb sill plate. The tab and/or flange when secured, increases the rigidity of the overall assembly by mechanically tying the door jamb stanchion into the sill plate. The shape of the shield in combination with the securing tabs and/or the bottom flange are major factors in the uniqueness of this component and the present system of invention. The technology allows the door jamb stanchion to be wrapped and braced and, once secured with screws, the stability of the jamb stanchion and door assembly is substantially increased. The door jamb shield has considerations for new manufactured door assemblies and may be incorporated into the door jamb stanchion area prior to application of the door assembly weather seal at the factory.

4. The upper door jamb stanchion shielding component corresponding to the door slab fixed edge (i.e., the hinge side) and coinciding door jamb stanchion will be an elongated section of about 16-24 gauge steel sheet metal or other rugged material that is generally configured to form an L shaped cross section. The hinge-side upper door jamb stanchion shielding component serves to wrap around the upper door jamb stanchion section from the facing surface of the door jamb adjacent the fixed edge of the door slab and around to the interior edge of the stanchion. The side of the shield corresponding to the longer leg of the L is positioned on the jamb stanchion immediately adjacent the free swinging door edge, while the side of the shield corresponding to the shorter portion of the L is situated against the interior edge of the same stanchion member. The hinge-side upper door jamb stanchion shielding component mounts on the jamb stanchion such that it flushly contacts the interior edge of the door jamb and the facing surface the hinge side jamb stanchion, while extending upward and downward in close proximity to the door jamb stanchion in both directions. When positioned accordingly, the extension flange at the top of the component will extend over and be secured to the upper rough frame and the extension flange at the bottom of the component will extend over and be secured to a portion of the door jamb stanchion. Alternatively a single top flange may extend and bend perpendicular to the top edge of the facing surface of the shield, while being positioned against and incorporated into the upper door jamb. These flanges, when secured, increase the rigidity of the overall assembly. The present component allows the door jamb to be wrapped in steel along two sides in the area of the hinge assembly and, once secured with suitable screws, the rigidity of the hinge assembly mounting area of the door jamb stanchion is greatly benefited with improved ability to resist force applied against the jamb stanchion. There will be a substantially rectangular cutout in one side of the component to allow for positioning around the hinge assembly. The cutout will be situated so as to be generally centered on the shield allowing substantially equal portions of the side panel to extend above and below the mounted hinge assembly as fixed to the door jamb member. The primary function of the component is to prevent forced entry by defeating of the conventional hinges and mounting hardware of typical door assemblies with sidelights. Secondly, this component will stabilize the door in the event of attempted forced entry on the lock side of the entry way. Research has shown that after continuous abuse the hinge side door jamb can fail. If this failure occurs the resulting door assembly instability creates the opportunity for the dead bolt plunger to easily disengage from the door jamb member and forcibly gain access. Once this occurs the entire door must be removed and extensively repaired or replaced. The wrapping features of the sleeve in combination with the securing flanges are major factors in the uniqueness of this component and the present system of invention. The technology allows the door jamb stanchion to be wrapped and braced and, once secured with screws, the stability of the jamb stanchion and door assembly is significantly increased. The component has considerations for new manufactured door assemblies and may be incorporated into the doorjamb stanchion area prior to application of the door assembly weather seal at the factory.

5. The lower door jamb stanchion shielding component corresponding to the door slab fixed edge and coinciding doorjamb will be an elongated section of about 16-24 gauge steel sheet metal or other rugged material that is generally configured to form an L shaped cross section. The hinge-side lower door jamb stanchion shielding component serves to wrap around the lower door jamb stanchion section from the facing surface of the door jamb adjacent the free swinging edge of the door slab and around to the interior edge of the stanchion. The side of the shield corresponding to the longer leg of the L is positioned on the jamb stanchion immediately adjacent the free swinging door edge, while the side of the shield corresponding to the shorter portion of the L is situated against the interior edge of the same stanchion member. The hinge-side lower door jamb stanchion shielding component mounts on the jamb stanchion such that it flushly contacts the interior edge of the doorjamb and the facing surface of the hinge side jamb stanchion, while extending upward and downward in close proximity to the doorjamb stanchion in both directions. When positioned accordingly, the bendable tab at the bottom of the component will bend inward and will receive a screw, thereby enabling the screw to be secured at an angle into the sill plate. Alternatively a single bottom flange may extend and bend perpendicular to the facing surface of the shield, while being positioned and incorporated into the sill plate. The tab and/or the flange, when secured, greatly increases the rigidity of the overall assembly by mechanically tying the door jamb stanchion into the sill plate. The present component allows the doorjamb to be wrapped in steel along two sides in the area of the lower hinge assembly and, once secured with suitable screws, the rigidity of the hinge assembly mounting area of the doorjamb stanchion is greatly benefited with improved ability to resist force applied against the jamb. There will be a substantially rectangular cutout in one side of the hinge side jamb shield to allow for positioning around the hinge assembly. The cutout will be situated so as to be generally centered on the shield allowing substantially equal portions of the side panel to extend above and below the mounted hinge assembly as fixed to the door jamb member. Units installed on new manufactured doors will be incorporated into the frame prior to installation of the door seal at the factory. The primary function of the “Hinge Shield” is to prevent forced entry by defeating of the conventional hinges and mounting hardware of typical door assemblies with sidelights. Secondly, this component will stabilize the door in the event of attempted forced entry on the lock side of the entry way. Research has shown that after continuous abuse the hinge side door jamb can fail. If this failure occurs the resulting door assembly instability creates the opportunity for the dead bolt plunger to easily disengage from the door jamb member and forcibly gain access. Once this occurs the entire door must be removed and extensively repaired or replaced. The wrapping features of the sleeve in combination with the securing tab are major factors in the uniqueness of this component and the present system of invention. The technology allows the door jamb stanchion to be wrapped and braced and, once secured with screws, the stability of the jamb stanchion and door assembly is substantially increased. The component has considerations for new manufactured door assemblies and may be incorporated into the doorjamb stanchion area prior to application of the door assembly weather seal at the factory.

6. The door shielding component, as previously disclosed, is an elongated section of about 16-24 gauge steel sheet metal or alternative rigid material that is generally U-shaped. The door shielding component serves to wrap around the free swinging edge of the door slab in the region corresponding to the lock bolts exiting the door. The door shielding component mounts with the bottom of the “U” on the free swinging edge of the door slab and the elongated side panels extending, in close proximity, along the interior and exterior faces of the door slab, towards the hinge side of the door. There are two openings in the bottom of the “U” positioned to allow the lock bolt mechanisms to operate without interference. The bolts of the upper and lower locks, when manipulated accordingly, will pass through the door shield component and into the facing surface of the jamb shield component before continuing as detailed in the jamb component description. Two more holes with coinciding orientation to the holes in the bottom of the “U” will pass through door shield component perpendicular to the aforementioned holes. These holes will serve as the lock mounting space. The primary function of the door shield component as applied to the present invention is to prevent force on the lock bolts from splitting the edge of the door slab. It subsequently serves to prevent tampering with the locking mechanism. Finally this component can be effective in preventing foreign objects from being forced between the door slab free swing edge and the door jamb interface by creating a much closer tolerance in this region. There are at least two versions of this component. A standard version allows for typical lock spacing between the dead bolt and latch bolt. Furthermore a universal application accommodates various lock spacing between the previously mentioned traditional locking mechanisms. The previously mentioned applications may be used singularly or in conjunction with one and other for multi point locking applications. The door shielding component may have considerations for new manufactured door assemblies and may be incorporated into the frame prior to installation of the door assembly weather seal at the factory.

7. The mounting hardware for each alternative component of the present invention will comprise appropriately sized screws. These screws should be sized to allow a minimum one inch penetration into the rough wood frame of an entry way. When mounting into masonry structures, comparable screws will be required. The mounting hardware component of the present invention be will suitable for this application and ensure that the door jamb portion of the door assembly is substantially secured to the rough frame of the surrounding structure, further assuring proper deployment of the system. As well the mounting hardware of the featured invention will need to be of a sort suited to inhibiting weather related deteriorating and corrosion.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a front elevation view, as seen from the interior of a dwelling or other structure, of a sidelight entry door assembly incorporating shield components described herein. FIGS. 1A, 1B and 1C are top, cross-sectional views of the door shown in FIG. 1 taken along lines A-A, B-B and C-C respectively.

FIG. 2 is a front elevation view, as seen from the interior of a dwelling or other structure, of an entry door assembly without any trim molding mounted around the doorway.

FIGS. 3A, 3B and 3C are front elevation, perspective, and side views of a sidelight door upper jamb shield for use on the free swinging door edge of an entry door assembly.

FIGS. 3D, 3E and 3F are front elevation, perspective, and side views of an alternative sidelight door upper jamb shield for use on the free swinging door edge of an entry door assembly.

FIGS. 4A, 4B and 4C are front elevation, perspective, and side views of a sidelight door center jamb shield for use on the free swinging door edge of an entry door assembly.

FIGS. 5A, 5B and 5C are front elevation, perspective, and side views of a sidelight door lower jamb shield for use on the free swinging door edge of an entry door assembly.

FIGS. 5D, 5E and 5F are front elevation, perspective, and side views of an alternative sidelight door lower jamb shield for use on the free swinging door edge of an entry door assembly.

FIGS. 6A and 6B are perspective views of a portion of a door jamb and door jamb shielding components corresponding to the free swinging door edge of an entry door assembly.

FIGS. 7A, 7B and 7C are front elevation, perspective and side views of a sidelight door upper jamb shield for use on the hinged door edge of an entry door assembly.

FIGS. 7D, 7E and 7F are front elevation, perspective, and side views of an alternative sidelight door upper jamb shield for use on the hinged door edge of an entry door assembly.

FIGS. 8A, 8B and 8C are front elevation, perspective and side views of a sidelight door lower jamb shield for use on the hinged door edge of an entry door assembly.

FIGS. 8D, 8E and 8F are front elevation, perspective, and side views of an alternative sidelight door lower jamb shield for use on the free swinging door edge of an entry door assembly.

FIGS. 9A and 9B are perspective views of the portion of a sidelight door jamb and a door jamb shielding components corresponding to the hinged door edge of an entry door assembly.

FIGS. 10A-C are front elevation, perspective and side views of alternative examples of a door slab reinforcement plate.

FIGS. 11A and 11B are perspective views of a door slab and door slab shield.

FIGS. 12A-E are perspective, front, side, rear, and end views of an alternative upper door jamb shield for use on the hinged door edge of an entry door assembly.

FIGS. 13A-E are perspective, front, side, rear, and end views of an alternative door jamb shield for use on the hinged door edge of an entry door assembly.

### DETAILED DESCRIPTION OF THE INVENTION

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

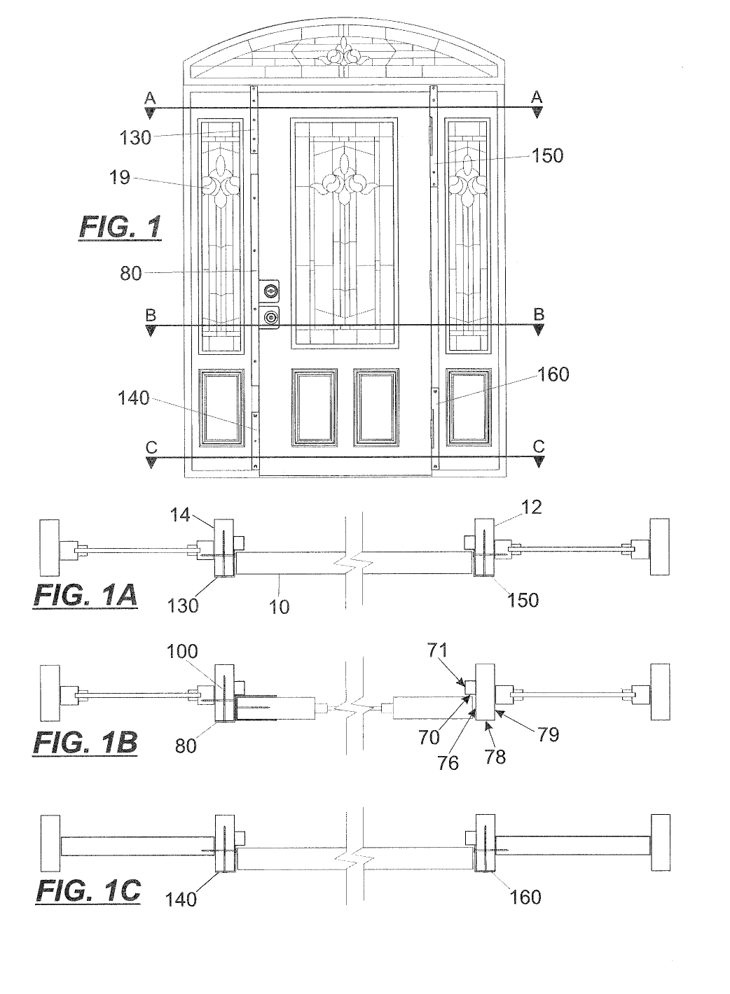

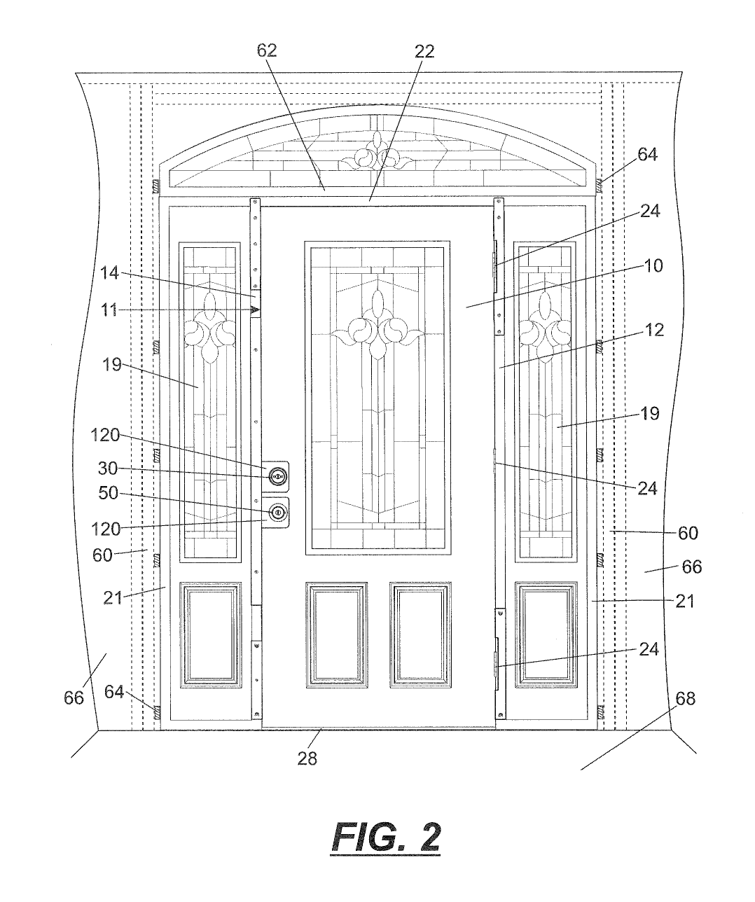

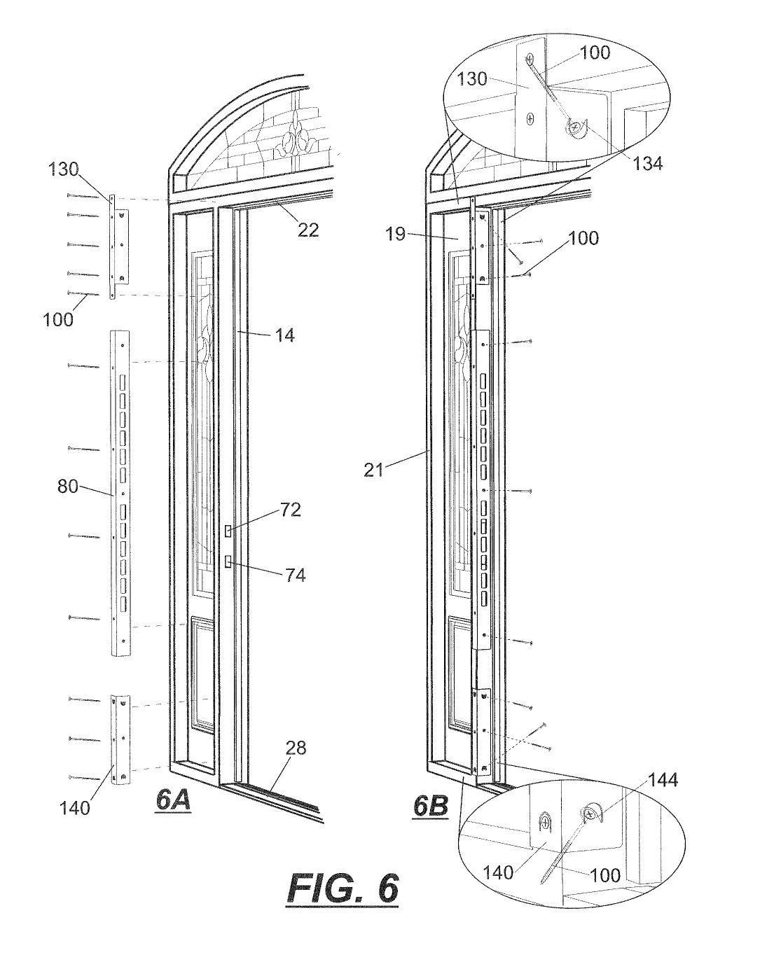

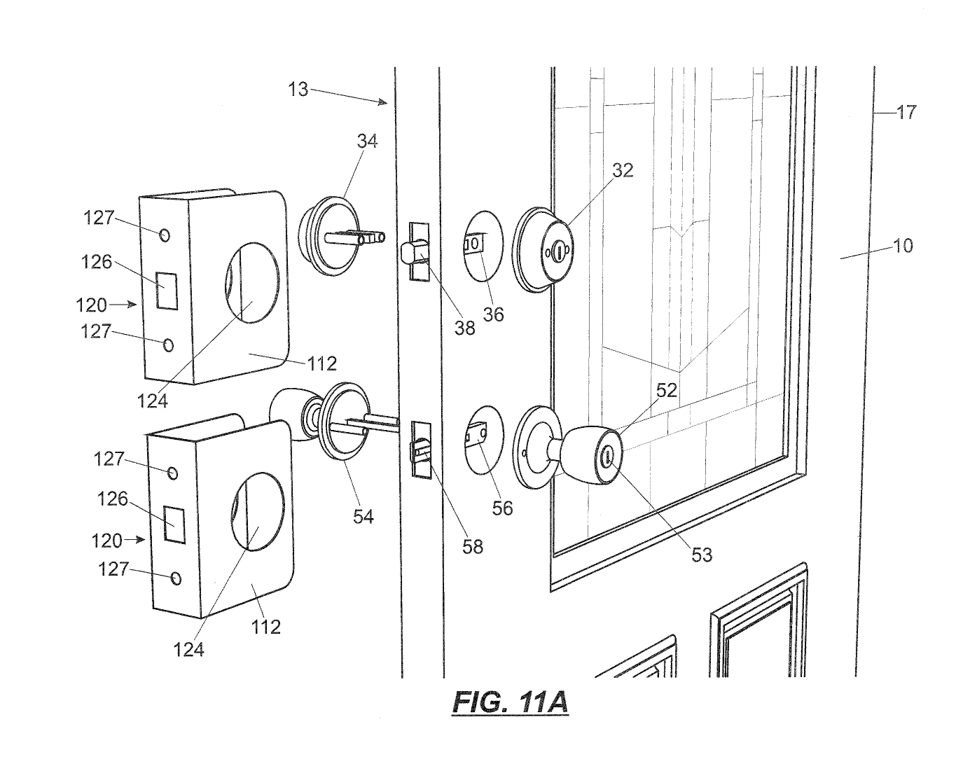

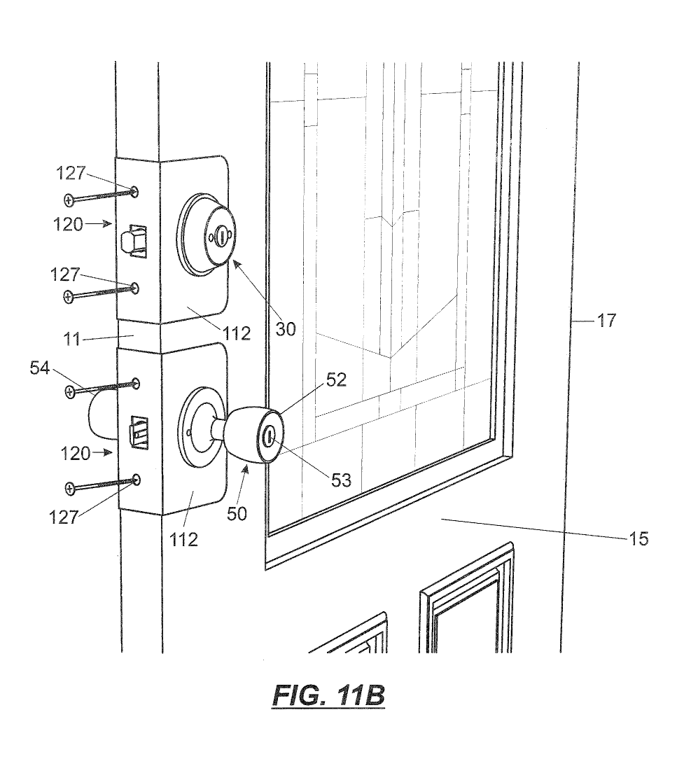

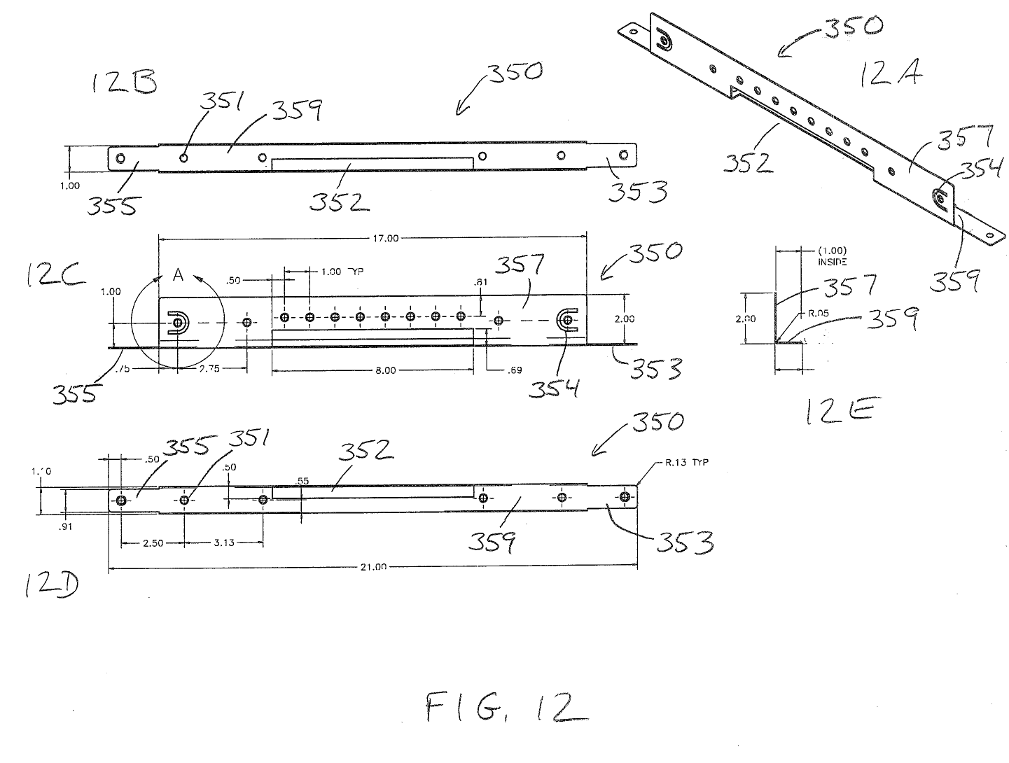

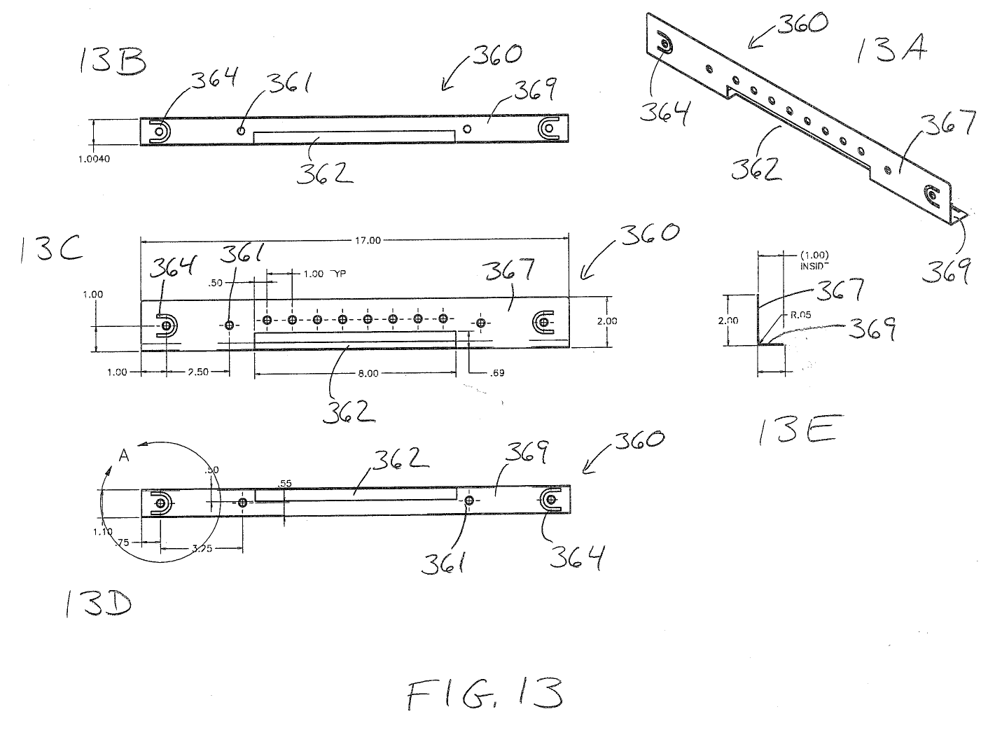

The present invention described and further detailed herein is particularly useful as a security device for the reinforcement of new door assemblies and equally suited for the repair of entry door assemblies with sidelights while the assembly remains in place. “In place” refers to the door assembly as mounted in an existing structure with means having been taken to ensure fixation to the structure in the current location. Accordingly a door assembly, as shown in FIGS. 1, 1A-C and FIG. 2, shall be an assembly including a door slab (10) mounted using (typically two or three) hinges (24) along one vertically elongated edge of the door slab and then fixed to the door jamb stanchion (12) allowing the door slab to swing and thus accommodate opening and closure. As well the door slab (10) shall have locking hardware (30)(50) mounted on the opposite vertical free swinging edge (11) so that this hardware may interface closely with the adjacent vertical door jamb stanchion member (14) upon door closure and lock actuation. Lock hardware shall typically involve a dead bolt (30) that has the locking mechanism (32) (34) (52) (54), as seen in FIGS. 11A and 11B, mounted both on the interior face (13) and exterior face (15) of the door and is manually manipulated by a key to lawfully unlock the door from the exterior side. A knob or key may be used to control the operation of the dead bolt lock bolt (36) from the interior side to engage and disengage lock bolt plunger (38) from the receiving opening (72 of FIG. 6A) of the door jamb stanchion (14). The lock bolt assembly (36) will extend perpendicularly, internal to the door slab, from the union of locking mechanisms (32)(34) on the door slab facing to the free swinging edge (11) where it is typically secured. A similarly arranged and actuated latch bolt assembly (50) shall be positioned some distance below the dead bolt (30) allowing the bolt plunger (58), of the latch bolt (56), to catch and remain engaged in the receiving opening (74 of FIG. 6A) of the corresponding vertical door jamb member, while the door is closed. The bolt plunger (58) of the latch bolt (56) can be retracted by manipulation of the door knobs (52)(54) that will be positioned on the interior and exterior faces of the door (13) (15), respectively, according to typical placement. The latch bolt locking assembly (50) is typically designed to accept a key, for lawful entry, in the exterior locking mechanism (53) positioned in the center in the door knob. The interior door knob (54) will be assembled with a manually operated knob (not illustrated), centrally located, that can be fingered to lock and unlock the latch bolt; thereby allowing for turning of the door knobs (52) (54) to disengage the latch bolt plunger (58) from the corresponding strike plate and receiving (74) opening in the door jamb member (14).

Returning again to FIGS. 1, 1A-C and 2, the doorjamb stanchions shall be ordinarily comprised of vertical jamb stanchions (12)(14) on opposite sides of the door slab that together with upper and lower common horizontal jamb members (22) (28) form the door opening. Each jamb member on its facing surface (i.e., the medial surface facing toward the door slab) will include an offset surface (70) along its length which will cause the member to recess and have two distinct planes along the facing surface (71) into which a weather barrier is mounted. The offset surface (70) shall serve as a sealing surface for the exterior door slab face (15) as well it will be a stop for the free swinging edge (11) in the closed position. Each jamb stanchion (12)(14) also has an interior surface (78) and a lateral surface (79) opposite the offset plane (76). (Each jamb stanchion (12)(14) also has an exterior surface opposite the interior surface, although this surface does not contact any elements of the present invention and is therefore not labeled in the figures.) The upper jamb member (22) and the vertical jamb stanchions (12)(14) are typically of wooden composition, while the lower jamb member (28) may be similarly created or of variable materials more resistant to weather-related long term damage. Additionally a pair of opposing wooden vertical jamb members (21) will be positioned some distance from the jamb stanchions on the side opposite that which interacts with the door slab (10). Decorative sidelight panels (19) of some width will be mounted between the vertical jamb stanchions (12)(14) and vertical jamb members (21) with the upper jamb (22) and sill plate (28) completing the sidelight enclosures. The sidelight panels are thereby enclosed between vertical jamb members (21), the upper jamb (22), the sill plate (28) and one of the vertical jamb stanchions (12)(14).

A pair of wooden vertical stud members (60) shall be immediately adjacent and parallel to the vertical jamb members (21), separated only by positioning shims (64). These studs (60) will be interposed between the walls of the structure (66) and joined together above and below the door jamb by a common header (62) and common floor (68) respectively to form the rough frame (60) (62) (68). The door assembly detail in FIG. 2 including the door enclosure (12)(14)(22)(28)(21)(19) is securely affixed in the rough frame (60) (62)(68), positioned true with shims (64) to ensure proper alignment and secured with suitable attaching hardware. Decorative molding shall conceal the area immediately around the door jamb (12)(14)(22)(28)(21)(19) on the inner as well as the outer walls (60) and extends along floor (68) of the structure.

Subsequently the door slab (10), on the affixed edge (17), is attached to the doorjamb stanchion (12) with common hinge assemblies (24) secured by relatively short screws that are ordinarily shallowly set in the soft wood substrate of the doorjamb stanchion. Accordingly the plunger portion of both lock bolts (38)(58) pass through a strike plate (not illustrated) of conventional construction and similarly mounted. The lock bolts engage the opposing vertical doorjamb stanchion (14) adjacent the door slab free swinging edge (11) and engage the bolt receiving openings (72) (74), very near the interior edge of the door jamb stanchion (14). Typically the bolt plunger of the dead bolt (38) will penetrate more deeply into the door jamb than the bolt plunger of the latch bolt (58) and consequently requires the receiving opening to be suitably sized.

Embodiments of the invention provide a door assembly security device that secures, reinforces and repairs a door assembly. The embodiment of FIG. 2 will demonstrate a security system including door jamb stanchion and door slab improvement shields suitably situated on a door assembly. The attached figures are examples of the mounting components in accordance with the current invention.

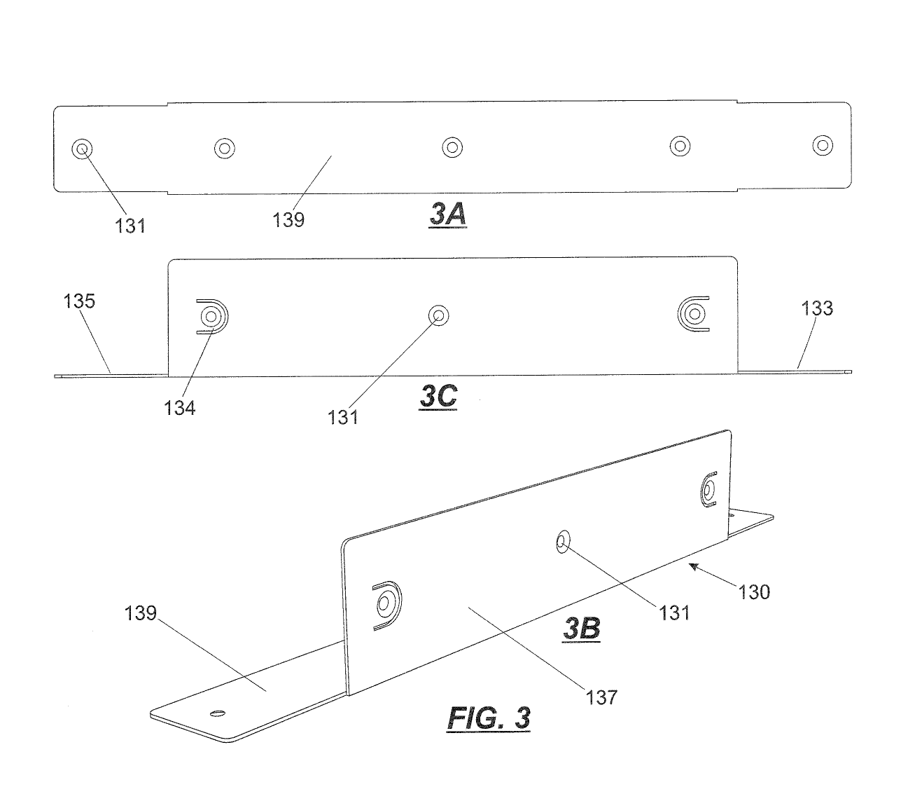

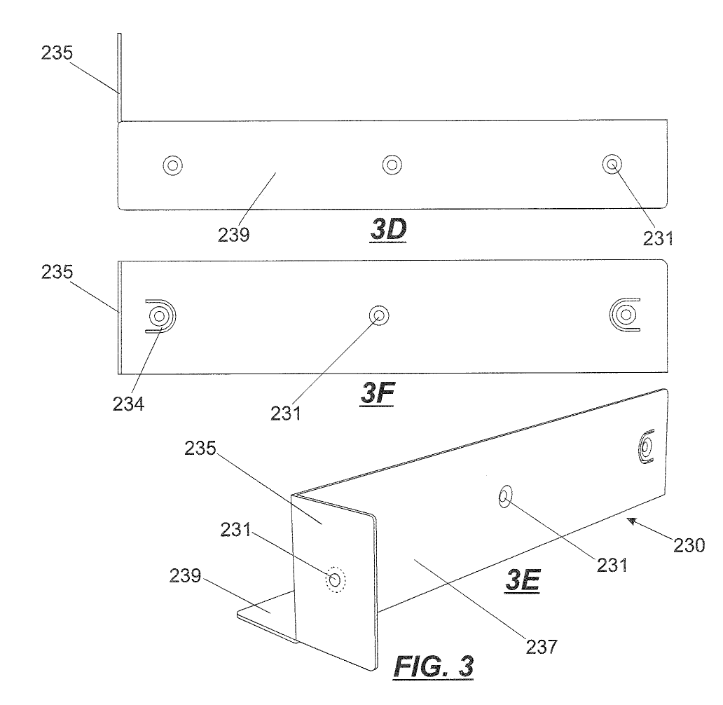

Additional FIGS. 3A-C and FIGS. 6A and B illustrate the upper door jamb stanchion shielding component (130), which is mounted on the upper portion of stanchion (14) (i.e., the stanchion that is adjacent to the free swinging edge of the door). The upper door jamb stanchion shielding component (130) is a metal elongated sleeve comprising a first panel (137) that is substantially perpendicular to a second panel (139), such that the upper door jamb stanchion shielding component (130) is shaped in a manner so as to generally present an L shaped cross section. The two opposing ends of the second panel extend beyond the corresponding ends of the first panel, such that the upper door jamb stanchion shielding component (130) further comprises two extension flanges (133)(135). The L shape of the shielding component (130) enable the shielding component to be affixed in a close contacting relationship to the upper portion of the door jamb stanchion such that a portion of the facing surface and the interior surface of the door jamb stanchion are covered by the shielding component (130) as seen in FIGS. 1A and 6B. The first panel (137) of the shielding component extends, in close proximity, along the offset plane (76) of the door jambs facing surface (71) on the free swinging side (11) of the door assembly. The second panel (139) of the shielding component is then contoured to advance perpendicular to the first panel and flushly contact the interior surface (78) of the door jamb stanchion. The second panel has extension flange (135) extending upward past the top end of the door jamb stanchion and over upper jamb member (22). The extension flange enables the shielding component to be secured to both the jamb stanchion and the upper jamb member. As the upper jamb member is more solidly constructed and therefore more durable than the jamb stanchion, this provides additional strength and security to the jamb stanchion. Because the shielding component has extension flanges at both ends, the shielding component can be used with doors whose hinges are on the right side (when viewed from inside the dwelling) (in which case flange (135) will extend over the upper jamb member, as seen in FIG. 6B) or with doors whose hinges are on the left side (when viewed from inside the dwelling) (in which case flange (133) will extend over the upper jamb member).

The component will have multiple countersunk openings (131) along the first panel (137) and the second panel (139) into which the mounting hardware (100) (e.g., wood screw) is secured. There may also be bendable securing tabs (134) at either end of the first panel (137). Two of the countersunk openings in the first panel are formed within the securing tabs as illustrated in FIGS. 3B and 3C. The first panel (137) of the upper jamb stanchion shielding component (130) will be secured to the door jamb stanchion (14) in the area of the narrowed offset plane (76) adjacent to the end where the stanchion abuts the upper horizontal jamb member (22), as seen in FIG. 6B. The component will be arranged such that the second panel (139) of the elongated metal sleeve (130) will be facing the interior edge (78) of the vertical door jamb member previously detailed and one of the two extension flanges (133)(135) (depending on which side of the door the hinges are on, as discussed above) will position over the upper jamb member (22) and rough frame (62). The first panel (137) of the metal sleeve will extend onto the offset plane (76) of the vertical door jamb member facing surface (71) with its extreme edge (i.e., the edge opposite the edge that is shared with the second panel) coming to rest flush against the offset surface (70) and behind the weather sealing component while maintaining a close parallel orientation to the offset plane (76). The second panel (139) will extend along flushly and be perpendicular to the vertical door jamb stanchion's lateral surface (79). The first panel (137) adjoins the second panel so that the first and second panels are substantially perpendicular to each other. The width of the second panel is substantially the same as the thickness of the door jamb stanchion. When correctly positioned the component is secured with suitable mounting hardware. This mounting hardware will constitute screws (100) that are placed in the countersunk openings (131) along the facing surfaces of the jamb shielding component (130). After properly preparing the material immediately beneath the countersunk opening (131), by means of pre-drilling, the screws are received in the opening such that the screws pass through the jamb shielding component (130) and extend substantially into the corresponding jamb stanchion. The areas of the jamb stanchion behind the top bendable tab must be prepared by removing sufficient material, such as by drilling, to make space to enable the tab to be bent inward (i.e., toward the stanchion). After properly preparing the material immediately beneath the bendable tab (134), the tab will be bent into the corresponding hole at an angle, as illustrated in the top inset in FIG. 6B. The resulting angle of the tab enables the screw (100) to be inserted at an upward angle, and thereby penetrate into the upper jamb member (22) for additional strength and security. When sufficiently engaged the screws heads will come to rest in the countersunk opening (131) of the component and appear to be in the same plane. (Note that while FIG. 1B only shows elements 70, 71, 76 labeled on stanchion 12, these same elements are also present on stanchion 14.)

The upper door jamb stanchion shielding component (130) of FIG. 3 may be mounted on a free-swinging side door jamb stanchion (for door assemblies with a free-swinging side sidelight panel) or may be mounted on a free-swinging side vertical jamb member (for door assemblies without a free-swinging side sidelight panel) (this latter arrangement is not illustrated).

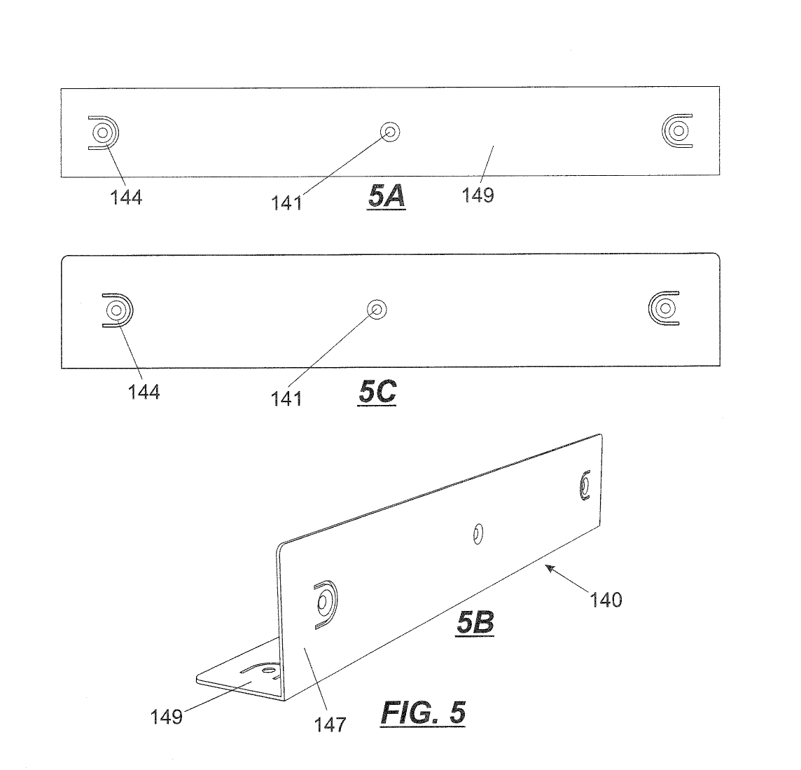

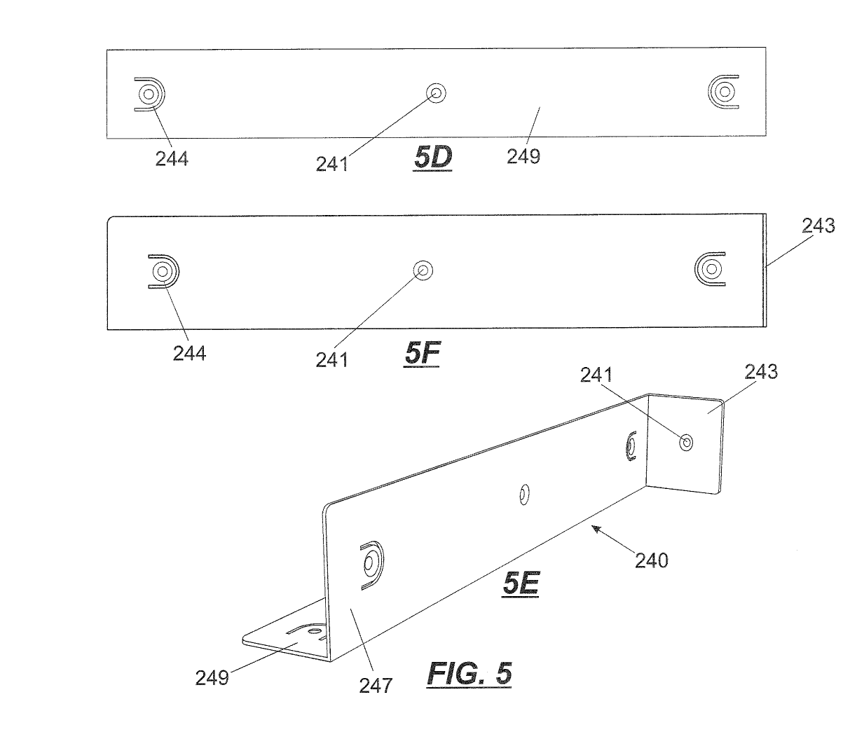

In an alternative embodiment illustrated in FIGS. 3D-F, an upper door jamb stanchion free-swinging side shielding component (230) comprises a first panel (237) and a second panel (239) that is substantially perpendicular to the first panel. The shield of FIGS. 3D-F is similar to that of FIGS. 3A-C, except that (a) there are no extension flanges on the second panel of the alternative embodiment, and (b) the alternative embodiment has an upper flange (235) that is perpendicular to the first panel as depicted in FIGS. 3D-F (this perpendicular arrangement of the flange contrasts with the upper door jamb stanchion shielding component (130) of FIGS. 3A-C in which the flanges (135) are planar with the second panel). Like the embodiment of FIGS. 3A-C, the alternative embodiment of FIGS. 3D-F is mounted on the upper portion of the door jamb stanchion such that the first panel flushly contacts the offset plane (76) of the jamb stanchion and the second panel flushly contacts the interior surface (78) of the jamb stanchion. The flange (235) of the shield (230) flushly contacts the underside of the upper jamb member (22) adjacent to where the jamb stanchion abuts the upper jamb member. The flange (235) has a countersunk opening (231) that will receive attaching hardware. When positioned as described above, the alternative shield (230) is secured with attaching hardware that when sufficiently engaged the screws heads will come to rest in the countersunk opening (231) of the component and appear to be in the same plane. The first and/or second panel may also include bendable tabs (234) for enabling some of the screws to be inserted into the jamb at an angle, as previously described. The attaching hardware that is received by the countersunk opening in the flange (235) will pass through the upper door jamb (22), through any applicable shim material (64), and penetrate sufficiently into the upper rough frame (62). The alternative upper door jamb stanchion shielding component (230) of FIGS. 3D-F can be used with doors whose hinges are on the right side (when viewed from inside the dwelling) (in which case flange (235) will flushly contact the underside of the portion of the upper jamb member that is above the door slab) or with doors whose hinges are on the left side (when viewed from inside the dwelling) (in which case flange (235) will flushly contact the underside of the portion of the upper jamb member that is above the sidelight). In another alternative embodiment (which is illustrated in FIGS. 5D-F), the flange may be on the opposite end of the first panel from what is illustrated in FIGS. 3D-F. In yet another alternative embodiment (not illustrated), the second panel could have extension flanges (as in the embodiment of FIGS. 3A-C) and the first panel could also have a flange (as in the embodiment of FIGS. 3D-F) (i.e., a combination of the elements of FIGS. 3A-C and FIGS. 3D-F).

The embodiment of FIGS. 5A-C and FIGS. 6A and B illustrate the lower door jamb stanchion shielding component (140), which is mounted on the lower portion of stanchion 14 (i.e., the stanchion that is adjacent to the free swinging edge of the door). The lower door jamb stanchion shielding component (140) is a metal elongated sleeve comprising a first panel (147) that is substantially perpendicular to a second panel (149) such that the upper door jamb stanchion shielding component (140) is shaped in a manner so as to generally present an L shaped cross section. The L shape of the shielding component (140) enable the shielding component to be affixed in a flushly contacting relationship to the lower portion of the door jamb stanchion such that a portion of the facing surface and the interior surface of the door jamb stanchion are covered by the shielding component (140) as seen in FIGS. 1C and 6B. The first panel (147) of the shielding component extends, in close proximity, along the offset plane (76) of the door jambs facing surface (71) on the free swinging side (11) of the door assembly. The second panel section (149) of the shielding component is then contoured to advance perpendicular to the first panel and flushly contacts the interior surface (78) of the door jamb stanchion. The shielding component (140) will have multiple countersunk openings (141) along the first panel (147) and the second panel (149) into which the mounting hardware (100) is secured. There may also be bendable securing tabs (144) at either end of the first panel (147) and second panel (149). Two of the countersunk openings in the first panel and two in the second panel are formed within the securing tabs as illustrated in FIGS. 5A-C. The first panel of the lower jamb stanchion shielding component (140) will be secured to the door jamb stanchion in the area of the narrowed offset plane (76) adjacent to the region where the stanchion abuts the sill plate (28), as seen in FIG. 6B. The component will be arranged such that the second panel (149) of the elongated metal sleeve (140) will be flushly contacting the interior edge (78) of the vertical door jamb member (14) previously detailed. The first panel (147) of the metal sleeve will extend onto the offset plane (76) of the vertical door jamb member facing surface (71) with its extreme edge (i.e., the edge opposite the edge that is shared with the second panel) coming to rest flush against the offset surface (70) and behind the weather sealing component while maintaining a close parallel orientation to the offset plane (76). The width of the second panel is substantially the same as the thickness of the door jamb stanchion. When correctly positioned the component is secured with suitable mounting hardware. This mounting hardware will constitute screws (100) that are placed in the countersunk openings (141) along the facing surfaces of the jamb shielding component (140). The areas of the jamb stanchion behind one or both of the bottom bendable tabs (i.e., the bottom tab on the first panel and/or the bottom tab on the second panel) must be prepared by removing sufficient material, such as by drilling, to make space to enable the tab(s) to be bent inward (i.e., toward the stanchion). After properly preparing the material immediately beneath the bendable securing tab(s) (144), by means of pre-drilling, the tab(s) will be bent into the corresponding hole at an angle to produce maximum penetration into the corresponding jamb stanchion (14), the sill plate (28) and the floor of the structure, as illustrated in the bottom inset in FIG. 6B. The resulting angle of the tab(s) enable the screw (100) to be inserted at a downward angle, and thereby penetrate into the sill plate and floor for additional strength and security. After properly preparing the material immediately beneath the countersunk opening (141), by means of pre-drilling, the screws are received in the opening such that the screws pass through the jamb shielding component (140) and extend substantially into the corresponding jamb stanchion. When sufficiently engaged the screws will come to rest in the countersunk opening (81) of the component and appear to be in the same plane.

The lower door jamb stanchion shielding component (140) of FIG. 5 may be mounted on a free-swinging side door jamb stanchion (for door assemblies with a free-swinging side sidelight panel) or may be mounted on a free-swinging side vertical jamb member (for door assemblies without a free-swinging side sidelight panel) (this latter arrangement is not illustrated).

In an alternative embodiment illustrated in FIGS. 5D-F, a lower door jamb stanchion free-swinging side shielding component (240) comprises a first panel (247) and a second panel (249) that is substantially perpendicular to the first panel. The shield of FIGS. 5D-F is similar to that of FIGS. 5A-C, except that the alternative embodiment has a lower flange (243) that is perpendicular to the first panel as depicted in FIGS. 5D-F. Like the embodiment of FIGS. 5A-C, the alternative embodiment of FIGS. 5D-F is mounted on the lower portion of the door jamb stanchion such that the first panel flushly contacts the offset plane (76) of the jamb stanchion and the second panel flushly contacts the interior surface (78) of the jamb stanchion. The flange (243) of the shield (240) flushly contacts the top of the lower jamb member (28) adjacent to where the jamb stanchion abuts the lower jamb member. The flange (243) has a countersunk opening (231) that will receive attaching hardware. When positioned as described above, the alternative shield (240) is secured with attaching hardware that when sufficiently engaged the screws heads will come to rest in the countersunk opening (231) of the component and appear to be in the same plane. The first and/or second panel may also include bendable tabs (244) for enabling some of the screws to be inserted into the jamb at an angle, as previously described. The attaching hardware that is received by the countersunk opening in the flange (243) will pass through the lower door jamb (28) and penetrate sufficiently into the floor (68). The alternative lower door jamb stanchion shielding component (240) of FIGS. 5D-F can be used with doors whose hinges are on the right side (when viewed from inside the dwelling) (in which case flange (243) will flushly contact the top surface of the portion of the lower jamb member that is below the door slab) or with doors whose hinges are on the left side (when viewed from inside the dwelling) (in which case flange (243) will flushly contact the top surface of the bottom horizontal portion of the sidelight frame). In another alternative embodiment (which is illustrated in FIGS. 3D-F), the flange may be on the opposite end of the first panel from what is illustrated in FIGS. 5D-F.

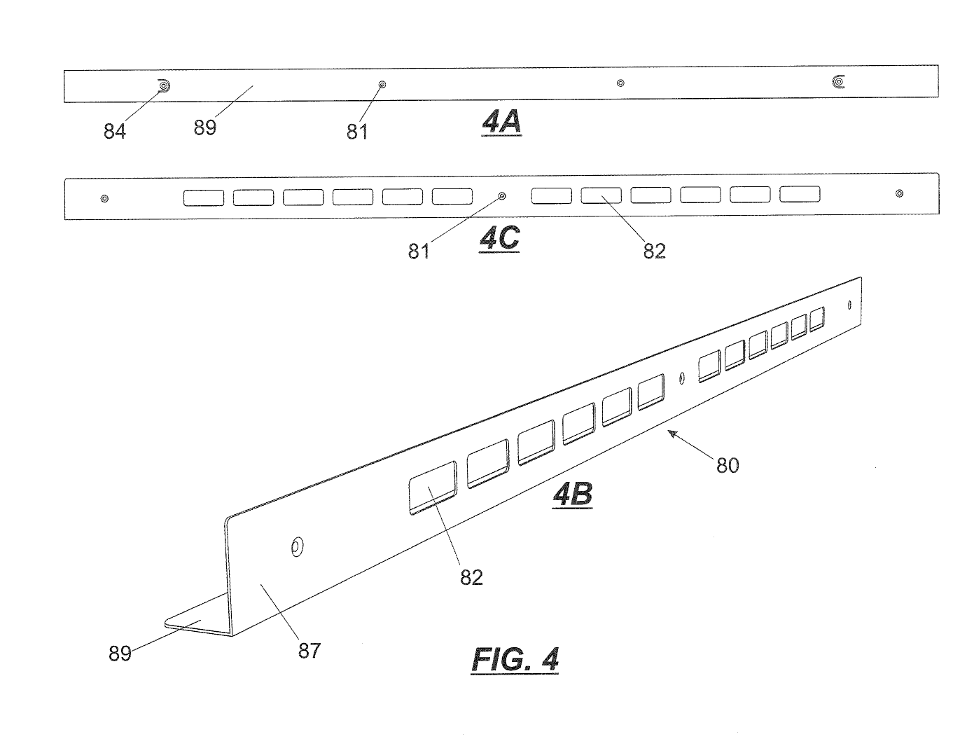

As seen in FIGS. 4A-C and FIGS. 6A and B, the center door jamb stanchion shielding component (80) corresponding to the free swinging edge of the door is a metal elongated sleeve shaped in a manner so as to generally present an L shaped cross section; thereby allowing it to extend, in close proximity, and be approximately centrally located along the offset plane (76) of the door jambs facing surface (71) of the door jamb stanchion corresponding to the free swinging edge of the door (14). The shield is then contoured to advance perpendicular and flushly contact the complete interior edge of the door jamb (78). The component will have multiple countersunk openings (81) along the first panel (87) and second panel (89) into which the mounting hardware (100) is secured. As well there will be a plurality of substantially identically sized cutouts or knockouts (82) approximately centered and aligned vertically along the length of the first facing surface. A number of the knockouts or cutouts will directly coincide with the lock bolt plunger receiving openings (72) (74) of the corresponding vertical door jamb stanchion (14). The center jamb shielding component (80) will be incorporated onto the door jamb stanchion in the area of the narrowed offset plane (76) specific to the region where the strike plates (26) are typically mounted around the lock bolt plunger receiving holes. The component will be arranged such that the second panel (89) of the elongated metal sleeve (80) will be flushly contacting the interior edge of the vertical door jamb stanchion (14) previously detailed. The first and second panels are substantially perpendicular to each other. The width of the second panel (89) is substantially the same as the thickness of the vertical door jamb stanchion. Accordingly when the jamb shielding component is arranged as previously mentioned the position is adjusted such that the knockouts or cutouts in the first panel (87) correspond, with specific alignment, to the bolt plunger receiving holes (72) (74) in the corresponding vertical door jamb member (14). When correctly positioned, the knockouts that align with the bolt plunger receiving holes (72) (74) are removed and the component is secured with suitable mounting hardware. This mounting hardware will constitute screws (100) that are placed in the countersunk openings (81) along the facing surfaces of the jamb shielding component (80). After properly preparing the material immediately beneath the countersunk opening (81), by means of pre-drilling, the screws are received in the opening such that the screws pass through the jamb shield component (80) and extend substantially into the door jamb stanchion (14). When sufficiently engaged the screw heads will come to rest in the countersunk opening (81) of the component and appear to be in the same plane. There may also be bendable securing tabs (84) at either end and/or in the center of the first panel (87) and/or second panel (89). Two of the countersunk openings in the second panel are formed within the securing tabs as illustrated in FIG. 4A. The areas of the jamb stanchion behind the bendable tabs must be prepared by removing sufficient material, such as by drilling, to make space to enable the tabs to be bent inward (i.e., toward the stanchion). After properly preparing the material immediately beneath the bendable tabs, the tabs will be bent into the corresponding hole at an angle. The resulting angle of the tab enables the screws (100) to be inserted at a non-perpendicular angle. Securing the screws at a non-perpendicular angle increases the amount of wood into which the screws are secured, thereby providing additional strength and security.

The center door jamb stanchion shielding component (80) of FIG. 4 may be mounted on a free-swinging side door jamb stanchion (for door assemblies with a free-swinging side sidelight panel) or may be mounted on a free-swinging side vertical jamb member (for door assemblies without a free-swinging side sidelight panel) (this latter arrangement is not illustrated).

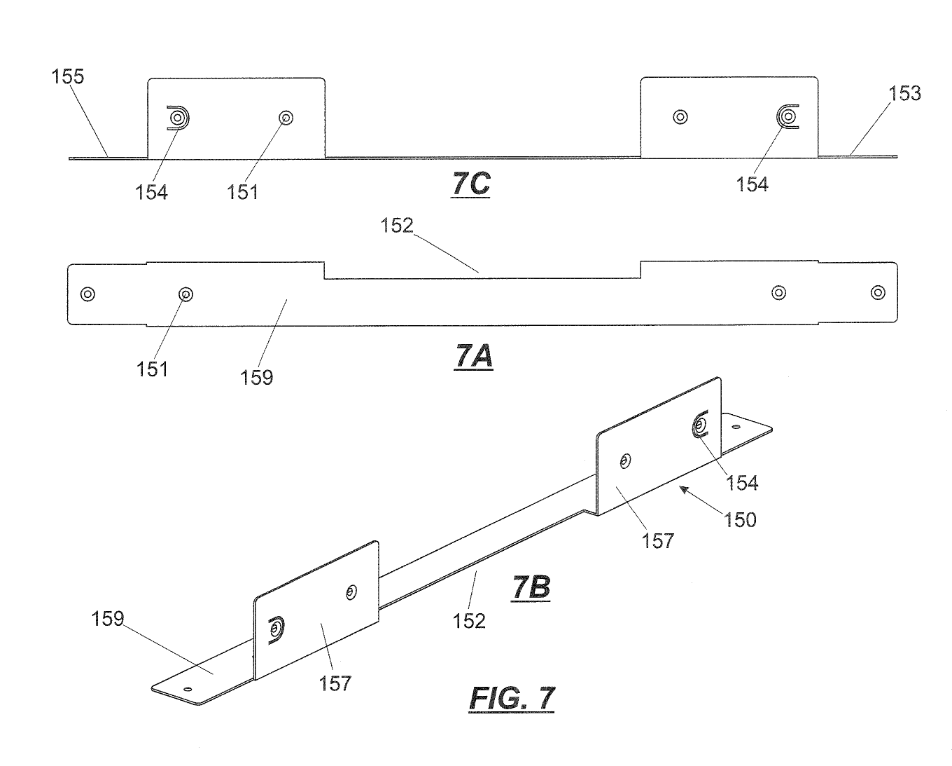

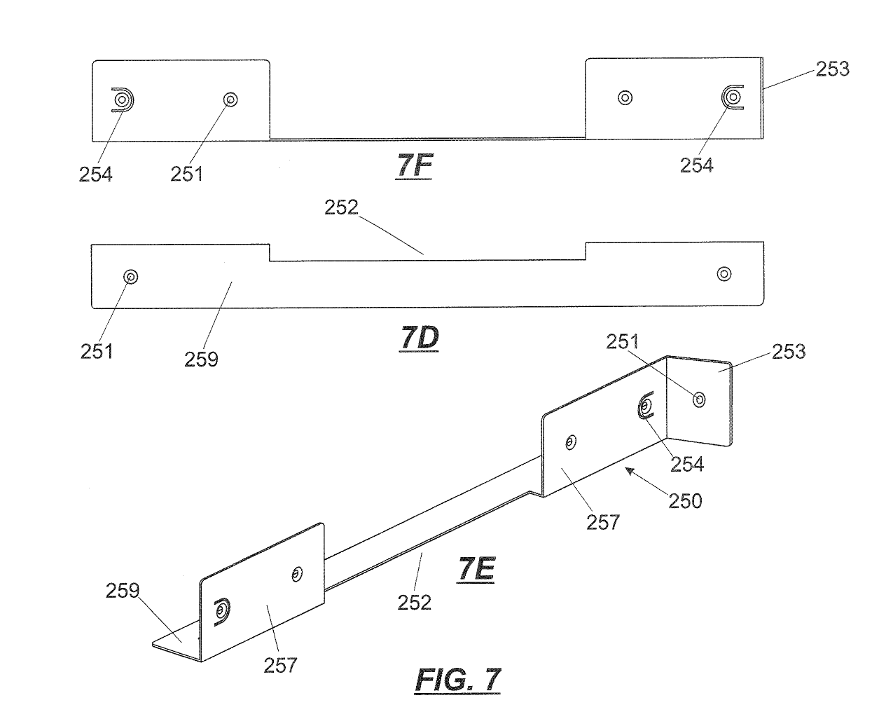

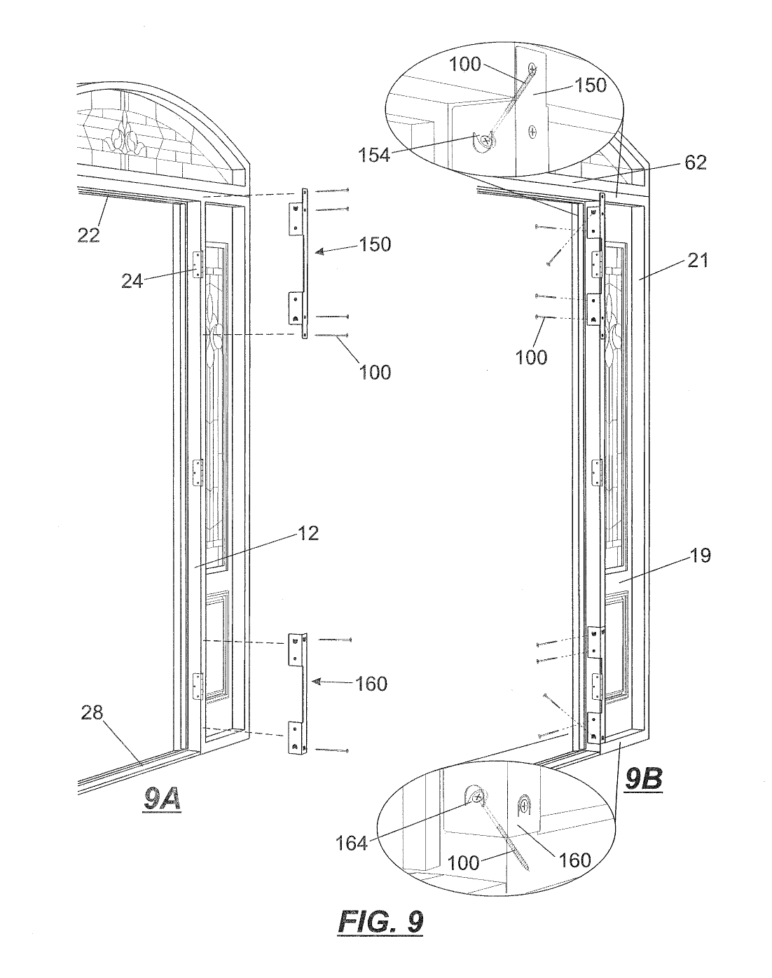

Additional FIGS. 7A-C and FIGS. 9A and B illustrate the upper door jamb stanchion hinge-side shielding component (150) which is mounted on the upper portion of stanchion 12 (i.e., the stanchion that is adjacent to the fixed or hinge side of the door). The hinge-side shielding component (150) is a metal elongated sleeve comprising a first panel (157) that is substantially perpendicular to a second panel (159) such that the upper door jamb stanchion shielding component (150) is shaped in a manner so as to generally present an L shaped cross section. The opposing two ends of the second panel extend beyond the corresponding ends of the first panel, such that the upper door jamb stanchion shielding component (150) further comprises two extension flanges (153)(155). The L shape of the shielding component (150) enable the shielding component to be affixed in a flushly contacting relationship to the upper portion of the door jamb stanchion such that a portion of the facing surface and the interior surface of the door jamb stanchion are covered by the shielding component (150) as seen in FIGS. 1A and 9B. The first panel (137) of the shielding component extends, in close proximity, along the offset plane (76) of the door jambs facing surface (71) on the hinged side (17) of the door assembly. The first panel will be formed with a substantially rectangular cutout (152) centrally located, to accommodate the fixed portion of the hinge (24), with substantially equivalent sections of the first panel (157) above and below the opening. As seen in FIG. 7B, the substantially rectangular cutout 152 spans an entire width of the first panel thereby dividing the first panel into separate top and bottom sections. The substantially rectangular cutout of the first panel is sized to correspond to a door hinge plate. As also seen in FIG. 7B, the second panel is also formed with a substantially rectangular cutout that is contiguous with the substantially rectangular cutout of the first panel. The substantially rectangular cutout of the second panel is sized to correspond to a door hinge barrel. The second panel (159) of the shielding component is then contoured to advance perpendicular to the first panel and flushly contact the interior surface (78) of the door jamb stanchion. Note that a portion of the second panel adjacent the cutout (152) is also cut out. The second panel has extension flange (153) extending upward past the top end of the door jamb stanchion and over upper jamb member (22) and rough frame (62) as illustrated in FIG. 9B. The extension flange enables the shielding component to be secured to both the jamb stanchion and the upper jamb member. As the upper jamb member is more solidly constructed and therefore more durable than the jamb stanchion, this provides additional strength and security to the jamb stanchion. Because the shielding component has extension flanges at both ends, the shielding component can be used with doors whose hinges are on the right side (when viewed from inside the dwelling) (in which case flange (153) will extend over the upper jamb member, as seen in FIG. 6B) or with doors whose hinges are on the left side (when viewed from inside the dwelling) (in which case flange (155) will extend over the upper jamb member).

The shielding component (150) will have multiple countersunk openings (151) along the first panel (157) and/or the second panel (159) into which the mounting hardware (100) (e.g., wood screw) is secured. There may also be bendable securing tabs (154) at either end of the first panel (157). Two of the countersunk openings in the first panel are formed within the securing tabs as illustrated in FIGS. 7B and 7C. The first panel of the upper jamb stanchion shielding component (150) corresponding to the hinge fixed side of the door slab will be secured to the door jamb stanchion in the area of the narrowed offset plane (76) adjacent to the end where the stanchion abuts the upper horizontal jamb member (22), as seen in FIG. 9B. The component will be arranged such that the second panel (159) of the elongated metal sleeve (150) will be flushly contacting the interior edge (78) of the vertical jamb member (12) previously detailed and one of the two extension flanges (153)(155) (depending on which side of the door the hinges are on, as discussed above) will position over the upper jamb member and rough frame and the other of the two extension flanges will position along the interior edge of the jamb stanchion. The first panel (157) of the sleeve will be constructed with an opening (152) along the facing surface large enough to accommodate hinge portion (24) previously mounted, in typical fashion, on the vertical jamb member (12). The first panel of the metal sleeve (157) will extend onto the offset plane of the vertical jamb member (12) facing surface (76) with its opening (152) centering on the hinge fixture (24). While positioned thusly the extreme edges (i.e., the edges opposite the edge that is shared with the center panel) of the equivalent upper and lower sections of first panel (157) will come to rest flush against the offset surface (70) and behind the weather sealing component while maintaining a close parallel orientation to the offset plane (76). The first panel (157) connects to the second side panel so that the first and second side panels are substantially perpendicular to each other. The width of second panel is substantially the same as the thickness of the door jamb stanchion. When correctly positioned, the component is secured with suitable mounting hardware. This mounting hardware will constitute screws (100) that are placed in the countersunk openings (151) along the facing surfaces of the jamb shielding component (150). After properly preparing the material immediately beneath the countersunk opening (151), by means of pre-drilling, the screws are received in the opening such that the screws pass through the jamb shielding component (150) and extend substantially into the corresponding jamb stanchion and rough frame (62). The areas of the jamb stanchion behind the top bendable tab must be prepared by removing sufficient material, such as by drilling, to make space to enable the tabs to be bent inward (i.e., toward the stanchion). After properly preparing the material immediately beneath the bendable tab (154), the tab will be bent into the corresponding hole at an angle, as illustrated in the top inset in FIG. 9B. The resulting angle of the tab enables the screw (100) to be inserted at an upward angle, and thereby penetrate into the upper jamb member (22),and/or the upper rough frame, for additional strength and security. When sufficiently engaged the screw heads will come to rest in the countersunk opening (151) of the component and appear to be in the same plane.

The upper door jamb stanchion hinge-side shielding component (150) of FIG. 7 may be mounted on a hinge-side door jamb stanchion (for door assemblies with a hinge-side sidelight panel) or may be mounted on a hinge-side vertical jamb member (for door assemblies without a hinge-side sidelight panel) (this latter arrangement is not illustrated).

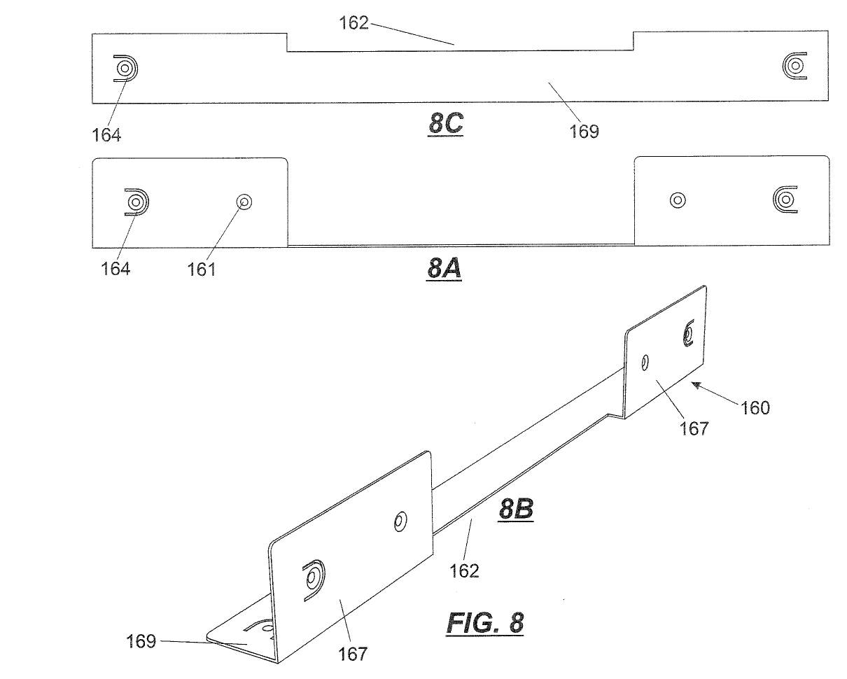

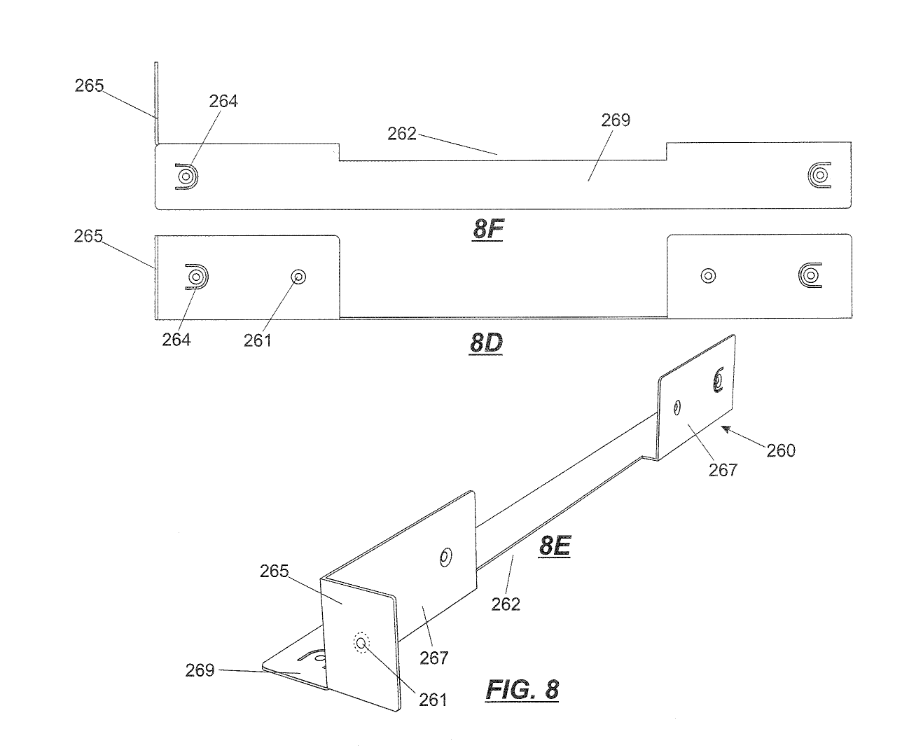

In an alternative embodiment illustrated in FIGS. 7D-F, an upper door jamb stanchion hinge side shielding component (250) comprises a first panel (257) and a second panel (259) that is substantially perpendicular to the first panel. The shield of FIGS. 7D-F is similar to that of FIGS. 7A-C, except that (a) there are no extension flanges on the second panel of the alternative embodiment, and (b) the alternative embodiment has an upper flange (253) that is perpendicular to the first panel as depicted in FIGS. 7D-F (this perpendicular arrangement of the flange contrasts with the upper door jamb stanchion shielding component (150) of FIGS. 7A-C in which the flanges (153)(155) are planar with the second panel). Like the embodiment of FIGS. 7A-C, the alternative embodiment of FIGS. 7D-F is mounted on the upper portion of the hinge side door jamb stanchion such that the first panel flushly contacts the offset plane (76) of the jamb stanchion (positioned such that the hinge plate is positioned within the horizontal cutout (252)) and the second panel flushly contacts the interior surface (78) of the jamb stanchion. The flange (253) of the shield (250) flushly contacts the underside of the upper jamb member (22) adjacent to where the jamb stanchion abuts the upper jamb member. The flange (253) has a countersunk opening (231) that will receive attaching hardware. When positioned as described above, the alternative shield (250) is secured with attaching hardware that when sufficiently engaged the screws heads will come to rest in the countersunk opening (231) of the component and appear to be in the same plane. The first and/or second panel may also include bendable tabs (254) for enabling some of the screws to be inserted into the jamb at an angle, as previously described. The attaching hardware that is received by the countersunk opening in the flange (253) will pass through the upper door jamb (22), through any applicable shim material (64), and penetrate sufficiently into the upper rough frame (62). The alternative upper door jamb stanchion shielding component (250) of FIGS. 7D-F can be used with doors whose hinges are on the right side (when viewed from inside the dwelling) (in which case flange (253) will flushly contact the underside of the portion of the upper jamb member that is above the door slab) or with doors whose hinges are on the left side (when viewed from inside the dwelling) (in which case flange (253) will flushly contact the underside of the portion of the upper jamb member that is above the sidelight). In another alternative embodiment (which is illustrated in FIGS. 8D-F), the flange may be on the opposite end of the first panel from what is illustrated in FIGS. 7D-F.

In yet another alternative embodiment (not illustrated), the second panel could have extension flanges (as in the embodiment of FIGS. 7A-C) and the first panel could also have a flange (as in the embodiment of FIGS. 7D-F) (i.e., a combination of the elements of FIGS. 7A-C and FIGS. 7D-F).

The featured embodiment of FIGS. 8A-C and FIGS. 9A and B illustrate the lower door jamb stanchion hinge side shielding component (160), which is mounted on the lower portion of stanchion 12 (i.e., the stanchion that is adjacent to the fixed or hinge side of the door). The lower door jamb stanchion hinge side shielding component (160) is a metal elongated sleeve comprising a first panel (167) that is substantially perpendicular to a second panel (169), such that the lower door jamb stanchion hinge side shielding component (160) is shaped in a manner so as to generally present an L shaped cross section. The L shape of the shielding component (160) enables the shielding component to be affixed in a flushly contacting relationship to the lower portion of the door jamb stanchion such that a portion of the facing surface and the interior surface of the door jamb stanchion are covered by the shielding component (160) as seen in FIGS. 1C and 9B. The first panel (167) of the shielding component extends, in close proximity, along the offset plane (76) of the door jambs facing surface (71) on the hinge side (17) of the door assembly. The second panel (169) of the shielding component is then contoured to advance perpendicular and flushly contact the interior surface (78) of the door jamb stanchion. The lower door jamb stanchion hinge side shielding component will have multiple countersunk openings (161) along the first panel (167) and the second panel (169) into which the mounting hardware (100) is secured. There may also be bendable securing tabs (164) at either end of the first panel (167) and/or either end of the second panel (169). Two of the countersunk openings in the first panel and two in the second panel are formed within the securing tabs as illustrated in FIGS. 8A-C. The first panel (167) of the lower jamb stanchion hinge side shielding component (160) will be secured to the door jamb stanchion in the area of the narrowed offset plane (76) adjacent to the region where the stanchion abuts the sill plate (28), as seen in FIG. 9B. The component will be arranged such that the second panel (169) of the elongated metal sleeve (160) created by the fore mentioned coinciding perpendicular bend of the sleeve will be facing the interior edge (78) of the vertical door jamb member (12) previously detailed. The first panel (167) of the sleeve will be constructed with an opening (162) along the facing surface large enough to accommodate hinge portion (24) previously mounted, in typical fashion, on the vertical jamb member (12). As seen in FIG. 8B, the substantially rectangular cutout 162 spans an entire width of the first panel thereby dividing the first panel into separate top and bottom sections. The substantially rectangular cutout of the first panel is sized to correspond to a door hinge plate. As also seen in FIG. 8B, the second panel is also formed with a substantially rectangular cutout that is contiguous with the substantially rectangular cutout of the first panel. The substantially rectangular cutout of the second panel is sized to correspond to a door hinge barrel. The first panel (167) of the metal sleeve will extend onto the offset plane (76) of the vertical door jamb member (12) facing surface with its opening (162) centering on the hinge fixture (24). While positioned thusly the extreme edges (i.e., the edges opposite the edge that is shared with the second panel) of the upper and lower sections of (167) will come to rest flush against the offset surface (70) and behind the weather sealing component while maintaining a close parallel orientation to the offset plane (76). The second panel (169) connects to the first panel so that the first and second side panels are substantially perpendicular to each other. The width of the second panel (169) is substantially the same as the thickness of the door jamb stanchion. When correctly positioned the component is secured with suitable mounting hardware. This mounting hardware will constitute screws (100) that are placed in the countersunk openings (161) along the first and/or second panels of the jamb shielding component (160). The areas of the jamb stanchion behind one or both of the bottom bendable tabs (i.e., the bottom tab on the first panel and/or the bottom tab on the second panel) must be prepared by removing sufficient material, such as by drilling, to make space to enable the tab(s) to be bent inward (i.e., toward the stanchion). After properly preparing the material immediately beneath the bendable securing tab(s) (164), by means of pre-drilling, the tab(s) will be bent into the corresponding hole at an angle to produce maximum penetration into the corresponding jamb stanchion (12), the sill plate (28) and the floor of the structure, as illustrated in the bottom inset in FIG. 9B. The resulting angle of the tab(s) enable the screw (100) to be inserted at a downward angle, and thereby penetrate into the sill plate and floor for additional strength and security. After properly preparing the material immediately beneath the countersunk opening (161), by means of pre-drilling, the screws are received in the opening such that the screws pass through the jamb shielding component (160) and extend substantially into the corresponding jamb stanchion. When sufficiently engaged the screw heads will come to rest in the countersunk opening (161) of the component and appear to be in the same plane.

The lower door jamb stanchion hinge-side shielding component (160) of FIG. 8 may be mounted on a hinge-side door jamb stanchion (for door assemblies with a hinge-side sidelight panel) or may be mounted on a hinge-side vertical jamb member (for door assemblies without a hinge-side sidelight panel) (this latter arrangement is not illustrated).

In an alternative embodiment illustrated in FIGS. 8D-F, a lower door jamb stanchion hinge side shielding component (260) comprises a first panel (267) and a second panel (269) that is substantially perpendicular to the first panel. The shield of FIGS. 8D-F is similar to that of FIGS. 8A-C, except that the alternative embodiment has a lower flange (265) that is perpendicular to the first panel as depicted in FIGS. 8D-F. Like the embodiment of FIGS. 8A-C, the alternative embodiment of FIGS. 8D-F is mounted on the lower portion of the door jamb stanchion such that the first panel flushly contacts the offset plane (76) of the jamb stanchion (positioned such that the hinge plate is positioned within the horizontal cutout (262)) and the second panel flushly contacts the interior surface (78) of the jamb stanchion. The flange (265) of the shield (260) flushly contacts the top of the lower jamb member (28) adjacent to where the jamb stanchion abuts the lower jamb member. The flange (265) has a countersunk opening (261) that will receive attaching hardware. When positioned as described above, the alternative shield (260) is secured with attaching hardware that when sufficiently engaged the screws heads will come to rest in the countersunk opening (261) of the component and appear to be in the same plane. The first and/or second panel may also include bendable tabs (264) for enabling some of the screws to be inserted into the jamb at an angle, as previously described. The attaching hardware that is received by the countersunk opening in the flange (265) will pass through the lower door jamb (28) and penetrate sufficiently into the floor (68). The alternative lower door jamb stanchion shielding component (260) of FIGS. 8D-F can be used with doors whose hinges are on the right side (when viewed from inside the dwelling) (in which case flange (265) will flushly contact the top surface of the portion of the lower jamb member that is below the door slab) or with doors whose hinges are on the left side (when viewed from inside the dwelling) (in which case flange (265) will flushly contact the top surface of the bottom horizontal portion of the sidelight frame). In another alternative embodiment (which is illustrated in FIGS. 7D-F), the flange may be on the opposite end of the first panel from what is illustrated in FIGS. 8D-F.

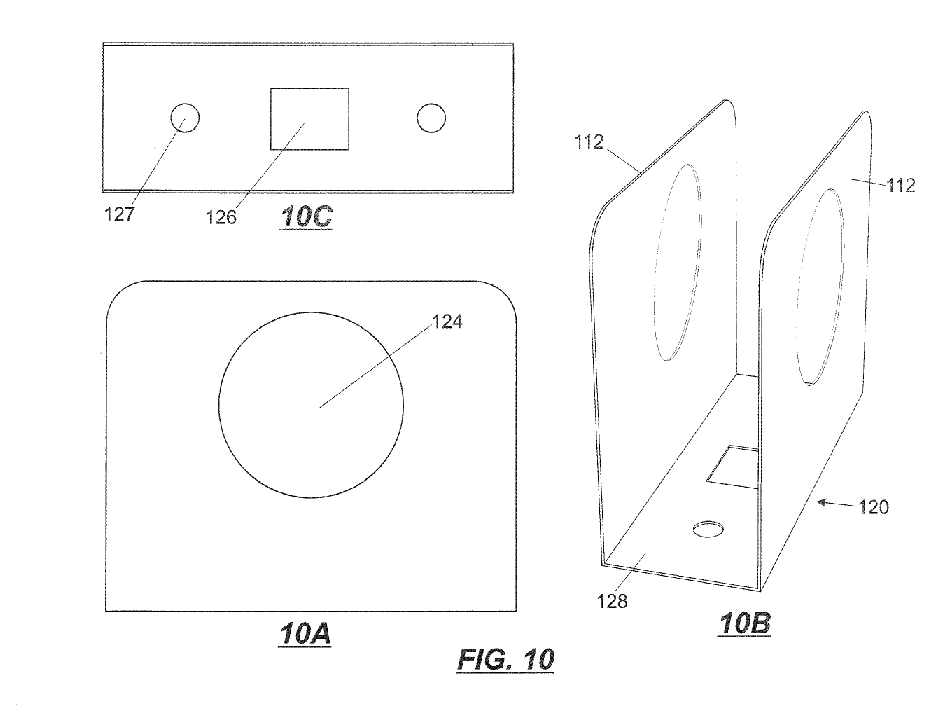

As represented in FIGS. 10A-C and FIGS. 11A and B the door shielding component of embodiments of the invention is an elongated steel sleeve (120) that has a U-shaped cross-section in a manner to have a common center section (128) flushly contacting the free swinging edge (11) of the door slab. The sleeve will be constructed with an opening (126) in this portion that is positioned to coincide with specific alignment and accommodate the lock bolt plunger (38) (58) operation as it is manipulated to extend and retract from the door slab edge (11) while respectively engaging and disengaging the corresponding vertical jamb stanchion member (14). The door shield component is further contoured to have perpendicular side panels (112) paralleling and in close proximity to the large facing surfaces (13) (15) of the door slab. The side panels (112) have openings (124) sufficiently sized for installation of typical locking devices (30) (50) as previously detailed. The component will be arranged such that the open section of the elongated metal sleeve created by the fore mentioned coinciding perpendicular bends of the sleeve will be immediately against the free swinging edge (11) of the door slab. In this position the opening (126) in this portion will coincide with specific alignment of the lock bolt plungers (38) (58), thereby permitting the lock bolt plungers to be manipulated to extend and retract from the door slab edge (11) while respectively engaging and disengaging the corresponding vertical jamb stanchion member (14). Resulting in the side panels (112) extending, snugly against the interior and exterior facing surfaces (13) (15), towards the fixed edge (17) of the door slab. Fasteners are inserted through holes (127) and secured into the door slab edge (11) to secure the sleeve

In use, the present system of invention can be characterized by its ease of installation, adaptability, superior design and simplicity. Briefly the steps for installation follow: Remove interior trim modeling and strike plates (67)(26). Position the jamb shielding components (130) (140) (80) ensuring the line up with the lock bolt plungers openings (72) (74). Form holes in the corresponding door jamb member or jamb stanchion for reception of screws at the countersunk locations (81)(131)(141), and form holes at the appropriate locations that are large enough to receive the bendable tabs. Bend the bendable tabs inward at the appropriate locations. Secure the jamb shielding components in place with suitable screws (100). Position the hinge side jamb shielding components (150)(160). Form holes in the corresponding door jamb member (12), as detailed at countersunk locations (153)(163), for the reception of screws, and form holes in the appropriate locations that are large enough to receive the bendable tabs. Bend the bendable tabs inward at the appropriate locations. Secure the hinge side jamb shield in place as detailed with suitable fore mentioned screws. Remove the locking devices (30) (50) from the door slab surfaces (13) (15). Position the door shield component on the door slab free swinging edge so as to allow the lock bolt plungers (38) (58) to pass through the corresponding openings in it (116). Secure the component in place with suitable screws and re-install the locking devices (30) (50) over the door shield component side panels (112), securing it in place.

The different shield components described herein are typically made of steel for strength reasons. Other metals or strong materials may alternatively be used to form the shields. Also, the actual dimensions of the various shield components may vary. The door jamb shield sleeve used for the door slab free swinging edge is from about six inches to about five feet long, or alternatively about one foot to three feet long, or in one example about twenty inches long. The corresponding side panels have widths of from about one-half inch to about six inches. In one example, the first panel is about an inch wide, and the second panel is about three inches wide. For a door jamb shield sleeve used on the door hinge side of the jamb, the sleeve is about four inches to two feet long, and in one example about six inches long. The side panels may have widths of from about one-half inch to about six inches. In one example, the first panel is about an inch wide, and the second panel is about three inches wide. The size and shape of the cutouts or knockouts are designed to correspond to the dimensions of the lock bolt receiving holes or hinge plate and are typically rectangular.

In applications involving repair of a door assembly, using the present invention, as much of the remaining door jamb member or door slab material as possible should be positioned to accept the appropriate components. When these door assemblies are severely damaged additional alignment maybe necessary to properly install the present system.

When the components of the present door security system are deployed alone or in combination as previously detailed they form a cohesive system that improves the security offered by a door assembly with sidelights. The components reinforce and retrofit existing doors assemblies and as well repairs damaged assemblies. These means are achieved by the components wrapping key elements of a door assembly in metal and securing them to the surrounding structure. The wrapping design reinforces these elements by placing metal along two sides of each piece and particularly along the typical load bearing surfaces exposed to a forced entry attempt, thereby preventing the splintering of the door assembly. The repair function allows for the door assembly elements to be easily repaired by sliding the door security components into place thereby wrapping the previously damaged areas. This will also serve to conceal the prior damage. On a typical door assembly with sidelights, this means the door jamb members on either side of the assembly, door stanchion corresponding to the free swinging, hinge side door jamb stanchion, door slab and a portion of the upper jamb member are wrapped in steel, while remaining in place, to repair or prevent further damage when substantial force is applied.

As discussed above, the alternative upper and lower free-swinging side door jamb stanchion shielding components (230)(240) can be used with doors whose hinges are on the right side (when viewed from inside the dwelling) (in which case the flange of the upper shield will flushly contact the underside of the portion of the upper jamb member that is above the door slab and the flange of the lower shield will flushly contact the top surface of the portion of the lower jamb member that is below the door slab) or with doors whose hinges are on the left side (when viewed from inside the dwelling) (in which case the flange of the upper shield will flushly contact the underside of the portion of the upper jamb member that is above the sidelight and the flange of the lower shield will flushly contact the top surface of the bottom horizontal portion of the sidelight frame). The upper and lower free-swinging side door jamb stanchion shielding components (230)(240) may be provided in a kit in which, if desired, the lower shield (240) can be used on the upper jamb of a door whose hinges are on the left side (when viewed from inside the dwelling) and the upper shield (230) can be used on the lower jamb of such a door. Reversing the mounting of the upper and lower shield in this manner enables the flanges of each to contact the portions of the respective lower and upper jamb members that are respectively below and above the door frame (rather than contact the portions of the respective lower and upper jamb members that are respectively below and above the sidelight).

As similarly discussed above, the alternative upper and lower hinge side door jamb stanchion shielding components (250)(260) can be used with doors whose hinges are on the right side (when viewed from inside the dwelling) (in which case the flange of the upper shield will flushly contact the underside of the portion of the upper jamb member that is above the door slab and the flange of the lower shield will flushly contact the top surface of the portion of the lower jamb member that is below the door slab) or with doors whose hinges are on the left side (when viewed from inside the dwelling) (in which case the flange of the upper shield will flushly contact the underside of the portion of the upper jamb member that is above the sidelight and the flange of the lower shield will flushly contact the top surface of the bottom horizontal portion of the sidelight frame). The upper and lower hinge side door jamb stanchion shielding components (250)(260) may be provided in a kit in which, if desired, the lower shield (260) can be used on the upper jamb of a door whose hinges are on the left side (when viewed from inside the dwelling) and the upper shield (250) can be used on the lower jamb of such a door. Reversing the mounting of the upper and lower shield in this manner enables the flanges of each to contact the portions of the respective lower and upper jamb members that are respectively below and above the door frame (rather than contact the portions of the respective lower and upper jamb members that are respectively below and above the sidelight).

In an alternative embodiment illustrated in FIGS. 12A-E, an upper door jamb stanchion hinge-side shielding component (350) which is mounted on the upper portion of stanchion 12 (i.e., the stanchion that is adjacent to the fixed or hinge side of the door). The hinge-side shielding component (350) is a metal elongated sleeve comprising a first panel (357) that is substantially perpendicular to a second panel (359) such that the upper door jamb stanchion shielding component (350) is shaped in a manner so as to generally present an L shaped cross section. The opposing two ends of the second panel extend beyond the corresponding ends of the first panel, such that the upper door jamb stanchion shielding component (350) further comprises two extension flanges (353)(355) formed by these extensions. The L shape of the shielding component (350) enables the shielding component to be affixed in a flushly contacting relationship to the upper portion of the door jamb stanchion such that a portion of the facing surface and the interior surface of the door jamb stanchion are covered by the shielding component (350) (similar to the illustration in FIGS. 1A and 9B of the mounting of shielding component (150)). The first panel (357) of the shielding component extends, in close proximity, along the offset plane (76) of the door jambs facing surface (71) on the hinged side (17) of the door assembly. The first panel will be formed with a substantially rectangular cutout (352) that is approximately centrally located, to accommodate the barrel portion of the hinge (24), with substantially equivalent sections of the first panel (357) above and below the opening. The substantially rectangular cutout of the first panel is sized to correspond to the door hinge barrel. Unlike the shielding component (150) of FIG. 7A-C, the substantially rectangular cutout (352) of shielding component (350) of FIG. 12 does not span the entire width of the first panel, but rather typically extends only far enough into the first panel (357) to accommodate the hinge barrel. As seen in FIGS. 12B and D, the second panel (359) is also formed with a substantially rectangular cutout (352) that is contiguous with the substantially rectangular cutout of the first panel. The substantially rectangular cutout of the second panel is also sized to correspond to the door hinge barrel. The second panel (359) of the shielding component is contoured to advance perpendicular to the first panel and flushly contact the interior surface (78) of the door jamb stanchion. The second panel has an extension flange (353 or 355) extending upward past the top end of the door jamb stanchion and over upper jamb member (22) and rough frame (62) (similar to the illustration in FIG. 9B of the mounting of shielding component (150)). The extension flange enables the shielding component to be secured to both the jamb stanchion and the upper jamb member. As the upper jamb member is more solidly constructed and therefore more durable than the jamb stanchion, this provides additional strength and security to the jamb stanchion. Because the shielding component has extension flanges at both ends, the shielding component can be used with doors whose hinges are on the right side (when viewed from inside the dwelling) (in which case flange (353) will extend over the upper jamb member) or with doors whose hinges are on the left side (when viewed from inside the dwelling) (in which case flange (355) will extend over the upper jamb member).

The shielding component (350) will have multiple countersunk openings (351) along the first panel (357) and/or the second panel (359) into which the mounting hardware (100) (e.g., wood screw) is secured. There may also be bendable securing tabs (354), for example at either end of the first panel (357). Two of the countersunk openings in the first panel are formed within the bendable securing tabs as illustrated in FIGS. 12A and C.

The first panel of the upper jamb stanchion shielding component (350) corresponding to the hinged side of the door slab will be secured to the door jamb stanchion in the area of the narrowed offset plane (76) adjacent to the end where the stanchion abuts the upper horizontal jamb member (22), as seen in FIG. 9B (FIG. 9B illustrates the mounting of shielding component (150), but the positioning and securing of shielding component (350) is nearly identical). The component will be arranged such that the second panel (359) of the elongated metal sleeve (350) will be flushly contacting the interior edge (78) of the vertical jamb member (12) and one of the two extension flanges (353)(355) (depending on which side of the door the hinges are on, as discussed above) will position over the upper jamb member and rough frame and the other of the two extension flanges will position along the interior edge of the jamb stanchion. The first panel (357) of the sleeve will be constructed with an opening (352) along the facing surface large enough to accommodate the hinge barrel previously mounted, in typical fashion, on the vertical jamb member (12). The first panel of the metal sleeve (357) will extend onto the offset plane of the vertical jamb member (12) facing surface (76) with its opening (352) centering on the hinge fixture (24). While positioned thusly the extreme edge (i.e., the edge opposite the edge that is shared with the second panel) of the first panel (357) will come to rest flush against the offset surface (70) and behind the weather sealing component while maintaining a close parallel orientation to the offset plane (76). The first panel (357) connects to the second panel so that the first and second panels are substantially perpendicular to each other. The width of second panel is typically substantially the same as the thickness of the door jamb stanchion, although it may be narrower. When correctly positioned, the component is secured with suitable mounting hardware. This mounting hardware will constitute screws (100) that are placed in the countersunk openings (351) along the facing surfaces of the jamb shielding component (350). After properly preparing the material immediately beneath the countersunk opening (351), by means of pre-drilling, the screws are received in the opening such that the screws pass through the jamb shielding component (350) and extend substantially into the corresponding jamb stanchion and rough frame (62). The areas of the jamb stanchion behind the top bendable tab must be prepared by removing sufficient material, such as by drilling, to make space to enable the tabs to be bent inward (i.e., toward the stanchion). After properly preparing the material immediately beneath the bendable tab (354), the tab will be bent into the corresponding hole at an angle, as illustrated in the top inset in FIG. 9B. The resulting angle of the tab enables the screw (100) to be inserted at an upward angle, and thereby penetrate into the upper jamb member (22), and/or the upper rough frame, for additional strength and security. When sufficiently engaged the screw heads will come to rest in the countersunk opening (351) of the component and appear to be in the same plane.

The upper door jamb stanchion hinge-side shielding component (350) of FIG. 12 may be mounted on a hinge-side door jamb stanchion (for door assemblies with a hinge-side sidelight panel) or may be mounted on a hinge-side vertical jamb member (for door assemblies without a hinge-side sidelight panel) (this latter arrangement is not illustrated).

In an alternative embodiment illustrated in FIGS. 13A-E, a door jamb stanchion hinge side shielding component (360) is a metal elongated sleeve comprising a first panel (367) that is substantially perpendicular to a second panel (369), such that the door jamb stanchion hinge side shielding component (360) is shaped in a manner so as to generally present an L shaped cross section. The shielding component (360) is mounted to the door jamb stanchion in a similar manner as the mounting of shielding component (160) illustrated in FIG. 9, except that the rectangular cutout (362) of shielding component (360) is different than that of (160) (as described in more detail below). The door jamb stanchion hinge side shielding component (360) may be mounted adjacent to any one or more of the plurality of hinges. For example, the door jamb stanchion hinge side shielding component (360) may be mounted adjacent both the top and bottom hinges, or may be mounted adjacent the bottom hinge with the door jamb stanchion hinge side shielding component (350) being mounted adjacent the top hinge. The door jamb stanchion hinge side shielding component (360) will have multiple countersunk openings (361) along the first panel (367) and/or the second panel (369) into which the mounting hardware is secured. There may be bendable securing tabs (364), typically at either end of the first panel (367) and/or the second panel (369). For example, FIGS. 13A-D illustrate two of the countersunk openings in the first panel being formed within the securing tabs and two of the countersunk openings in the second panel being formed within the securing tabs.

The first panel (367) of the sleeve will be formed with a substantially rectangular cutout (362) that is approximately centrally located, to accommodate the barrel portion of the hinge (24), with substantially equivalent sections of the first panel (367) above and below the opening. The substantially rectangular cutout of the first panel is sized to correspond to the door hinge barrel. Unlike the shielding component (160) of FIG. 8, the substantially rectangular cutout (362) of shielding component (360) of FIG. 13 does not span the entire width of the first panel, but rather typically extends only far enough into the first panel (367) to accommodate the hinge barrel. As seen in FIGS. 13B and D, the second panel (369) is also formed with a substantially rectangular cutout (362) that is contiguous with the substantially rectangular cutout of the first panel. The substantially rectangular cutout of the second panel is also sized to correspond to the door hinge barrel.

The mounting of shielding component (360) is similar to the mounting of shielding component (150) illustrated in FIG. 9B. The first panel of the metal sleeve (367) will extend onto the offset plane of the vertical jamb member (12) facing surface (76) with its opening (362) centering on the hinge fixture (24). While positioned thusly the extreme edge (i.e., the edge opposite the edge that is shared with the second panel) of the first panel (367) will come to rest flush against the offset surface (70) and behind the weather sealing component while maintaining a close parallel orientation to the offset plane (76). The first panel (367) connects to the second side panel so that the first and second side panels are substantially perpendicular to each other. The width of second panel is typically substantially the same as the thickness of the door jamb stanchion, although it may be narrower. The second panel (369) of the shielding component is contoured to advance perpendicular to the first panel and flushly contact the interior surface (78) of the door jamb stanchion.

When correctly positioned, the component is secured with suitable mounting hardware. This mounting hardware will constitute screws (100) that are placed in the countersunk openings (361) along the facing surfaces of the jamb shielding component (360). After properly preparing the material immediately beneath the countersunk opening (361), by means of pre-drilling, the screws are received in the opening such that the screws pass through the jamb shielding component (360) and extend substantially into the corresponding jamb stanchion and rough frame (62). The areas of the jamb stanchion behind the bendable tab must be prepared by removing sufficient material, such as by drilling, to make space to enable the tabs to be bent inward (i.e., toward the stanchion). After properly preparing the material immediately beneath the bendable tab (364), the tab will be bent into the corresponding hole at an angle, as illustrated in the top and bottom insets in FIG. 9B. The resulting angle of the tab enables the screw (100) to be inserted at an angle (an upward angle if the shielding component (360) is mounted adjacent the top hinge or a downward angle if the shielding component (360) is mounted adjacent the bottom hinge), and thereby penetrate into the upper or lower jamb member and/or the upper or lower rough frame for additional strength and security. When sufficiently engaged the screw heads will come to rest in the countersunk opening (361) of the component and appear to be in the same plane.

The shielding component (360) of FIG. 13 may be mounted on a hinge-side door jamb stanchion (for door assemblies with a hinge-side sidelight panel) or may be mounted on a hinge-side vertical jamb member (for door assemblies without a hinge-side sidelight panel) (this latter arrangement is not illustrated).

Having thus described and detailed the present invention, it is to be understood that many obvious and apparent variations in construction and arrangement may be made without departing from the overall scope and spirit thereof as defined by the appended claims. Furthermore, it is intended that the foregoing specifications and accompanying drawings be interpreted as illustrative rather than in a limiting sense.

That which is claimed:

1. A device for reinforcing a vertical jamb member of a door assembly, the vertical jamb member being adjacent a hinge side of a door, the device comprising:
an elongated, single piece, metal sleeve comprising first and second panels that are substantially perpendicular to each other, the first panel comprising a substantially rectangular cutout therein, the second panel comprising a substantially rectangular cutout contiguous with the substantially rectangular cutout of the first panel;
wherein the contiguous cutouts of the first and second panels are sized to correspond to a size of a door hinge barrel; and
wherein the sleeve is mounted such that the door hinge barrel is within the contiguous cutouts of the first and second panels.

2. The device of claim 1, wherein at least one of the first and second panels defines at least one bendable tab, the bendable tab defining an opening for receiving a fastener, the bendable tab being adapted to bend thereby enabling the fastener received by the bendable tab to be secured into the vertical jamb member at a non-perpendicular angle;

3. The device of claim 2, wherein each of the at least one bendable tabs is defined by a U-shaped slot in the corresponding first or second panel.

4. The device of claim 1, wherein a width of the second panel is substantially the same as a thickness of the vertical jamb member.

5. The device of claim 1, wherein the first and second side panel have substantially different widths such that the sleeve has an L-shaped cross section.

6. The device of claim 1, wherein a length of the second panel is greater than a length of the first panel such that opposing ends of the second panel extend beyond corresponding opposing ends of the first panel thereby forming top and bottom extension flanges

7. The device of claim 6, wherein the vertical jamb member comprises a door jamb stanchion, the door jamb stanchion comprising a vertical support post positioned between the hinge side of the door and a sidelight panel, a top end of the door jamb stanchion abutting an upper horizontal jamb member, a bottom end of the door jamb stanchion abutting a lower horizontal jamb member; and
wherein the sleeve is mounted on an upper portion of the door jamb stanchion, such that a top end of the first panel abuts the upper horizontal jamb member, and such that the top extension flange of the second panel extends past the top end of the door jamb stanchion and covers a portion of the upper horizontal door jamb member.

8. A method for reinforcing a vertical jamb member of a door assembly, the vertical jamb member being adjacent a hinge side of a door, the device comprising:
providing an elongated, single piece, metal sleeve comprising first and second panels that are substantially perpendicular to each other, the first panel comprising a substantially rectangular cutout therein, the second panel comprising a substantially rectangular cutout contiguous with the substantially rectangular cutout of the first panel, the contiguous cutouts of the first and second panels being sized to correspond to a size of a door hinge barrel; and
mounting the sleeve on the vertical jamb member such that the door hinge barrel is within the contiguous cutouts of the first and second panels

9. The method of claim 8, wherein at least one of the first and second panels defines at least one bendable tab, the bendable tab defining an opening for receiving a fastener, the bendable tab being adapted to bend thereby enabling the fastener received by the bendable tab to be secured into the vertical jamb member at a non-perpendicular angle;

10. The method of claim 9 wherein each of the at least one bendable tabs is defined by a U-shaped slot in the corresponding first or second panel.

11. The method of claim 8, wherein a width of the second panel is substantially the same as a thickness of the vertical jamb member.

12. The method of claim 8, wherein the first and second side panel have substantially different widths such that the sleeve has an L-shaped cross section.

13. The method of claim 8, wherein a length of the second panel is greater than a length of the first panel such that opposing ends of the second panel extend beyond corresponding opposing ends of the first panel thereby forming top and bottom extension flanges

14. The method of claim 13, wherein the vertical jamb member comprises a door jamb stanchion, the door jamb stanchion comprising a vertical support post positioned between the hinge side of the door and a sidelight panel, a top end of the door jamb stanchion abutting an upper horizontal jamb member, a bottom end of the door jamb stanchion abutting a lower horizontal jamb member; and
wherein the sleeve is mounted on an upper portion of the door jamb stanchion, such that a top end of the first panel abuts the upper horizontal jamb member, and such that the top extension flange of the second panel extends past the top end of the door jamb stanchion and covers a portion of the upper horizontal door jamb member.
